(19) United States
(12) Patent Application Publication
(10) Pub. No.: US 2026/0278007 A1
(43) Pub. Date: Sep. 17, 2026

(54) Optimizing User Interactions and Task Selection for Large Language Models

(71) Applicant: Google LLC, Mountain View, CA (US)

(72) Inventors: Adam Joshua Bignell, Sunnyvale, CA (US); Miguel de Andrés-Clavera, Singapore (SG); Scott Bradley Huffman, Portola Valley, CA (US); Dale Amanda Markowitz, Austin, TX (US); Joshua Thomas Woodward, Sunnyvale, CA (US); Steven Johnson, Brooklyn, NY (US)

(21) Appl. No.: 19/469,269

(22) PCT Filed: Mar. 31, 2023
(86) PCT No.: PCT/US2023/017165

§ 371 Date: Sep. 25, 2025

(51) Int. Cl. G06F 16/903; G06F 16/9032; G06F 16/93

(52) U.S. Cl. CPC G06F 16/90335; G06F 16/90332; G06F 16/93

(57) ABSTRACT

Data indicative of a text query is received. A text embedding for the text query is generated using a machine-learned embedding generation model. A plurality of chunk embeddings respectively generated by the embedding generation model for a plurality of document chunks of the plurality of documents are accessed. The plurality of documents are organized into a plurality of document subsets. Data indicative of selected document subset(s) of the plurality of document subsets is obtained. A similarity search is performed for the text embedding with respect to only chunk embeddings that are associated with document chunks that are included in the selected document subset(s). The similarity search identifies chunk embedding(s) as semantically similar to the text query. Document chunk(s) that correspond to the chunk embedding(s) identified by the similarity search are provided for display within a user interface.

### FIELD

The present disclosure relates generally to optimizing task performance with large language models. More particularly, the present disclosure relates to optimizing interactions between users and large language models while selecting tasks for the large language models.

### BACKGROUND

Large language models are models that have been trained on enormous data sets. This manner of training provides large language models with the capability to perform multiple types of language tasks. For example, some language models can simplify text, generate contrarian opinions, facilitate brainstorming, respond to user queries in a conversational manner, etc. Used in combination, these tasks can facilitate a conversational dialogue between the model and a user to more efficiently provide the user with relevant information. However, the wide variety of tasks that the large language model can perform makes it difficult to select particular task(s) at any given time.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for semantic exploration of a specified subset of a plurality of documents. The method includes receiving, by a computing system comprising one or more computing devices, data indicative of a text query. The method includes generating, by the computing system using a machine-learned embedding generation model, a text embedding for the text query. The method includes accessing, by the computing system, a plurality of chunk embeddings respectively generated by the machine-learned embedding generation model for a plurality of document chunks of the plurality of documents, wherein the plurality of documents are organized into a plurality of document subsets. The method includes obtaining, by the computing system, data indicative of one or more selected document subsets of the plurality of document subsets. The method includes performing, by the computing system, a similarity search for the text embedding with respect to only chunk embeddings that are associated with document chunks that are included in the one or more selected document subsets, wherein the similarity search identifies one or more of the chunk embeddings as semantically similar to the text query. The method includes providing, by the computing system for display within a user interface, one or more of the plurality of document chunks that correspond to the one or more of the chunk embeddings identified by the similarity search.

Another example aspect of the present disclosure is directed to a computer system for semantic exploration of a specified subset of a plurality of documents. The computer system includes one or more processors and one or more non-transitory computer-readable media. The one or more non-transitory computer-readable media collectively store a plurality of chunk embeddings respectively generated by a machine-learned embedding generation model for a plurality of document chunks of the plurality of documents, wherein the plurality of documents are organized into a plurality of document subsets. The one or more non-transitory computer-readable media collectively store instructions that, when executed by the one or more processors, cause the computer system to perform operations. The operations include receiving data indicative of a text query. The operations include generating, using the machine-learned embedding generation model, a text embedding for the text query. The operations include obtaining data indicative of one or more selected document subsets of the plurality of document subsets. The operations include performing a similarity search for the text embedding with respect to only chunk embeddings that are associated with document chunks that are included in the one or more selected document subsets, wherein the similarity search identifies one or more of the chunk embeddings as semantically similar to the text query. The operations include providing, for display within a user interface, one or more of the plurality of document chunks that correspond to the one or more of the chunk embeddings identified by the similarity search.

Another example aspect of the present disclosure is directed to a computer-implemented method for large language model interactions with improved explainability. The method includes receiving, by a computing system comprising one or more computing devices, data indicative of a text query. The method includes generating, by the computing system using a machine-learned embedding generation model, a text embedding for the text query. The method includes performing, by the computing system, a similarity search for the text embedding with respect to a plurality of chunk embeddings respectively generated by the machine-learned embedding generation model for a plurality of document chunks of a plurality of documents, wherein the similarity search identifies as semantically similar to the text query one or more identified document chunks of the plurality of document chunks. The method includes generating, by the computing system, a prompt that comprises the one or more identified document chunks. The method includes providing, by the computing system, the prompt as an input to and for processing by a machine-learned large language model. The method includes receiving, by the computing system, a language output generated by the machine-learned large language model based on the processing of the prompt. The method includes providing, by the computing system, the language output as an output.

Another example aspect of the present disclosure is directed to a computer system for large language model interactions with improved explainability. The computer system includes one or more processors and one or more non-transitory computer-readable media that collectively store instructions that, when executed by the one or more processors, cause the computer system to perform operations. The operations include receiving data indicative of a text query. The operations include generating, using a machine-learned embedding generation model, a text embedding for the text query. The operations include performing a similarity search for the text embedding with respect to a plurality of chunk embeddings respectively generated by the machine-learned embedding generation model for a plurality of document chunks of a plurality of documents, wherein the similarity search identifies as semantically similar to the text query one or more identified document chunks of the plurality of document chunks. The operations include generating a prompt that comprises the one or more identified document chunks. The operations include providing the prompt as an input to and for processing by a machine-learned large language model. The operations include receiving a language output generated by the machine-learned large language model based on the processing of the prompt. The operations include providing the language output as an output.

Another example aspect of the present disclosure is directed to one or more non-transitory computer-readable media that store instructions that, when executed by one or more processors of a computing system, cause the computing system to perform operations. The operations include receiving data indicative of a text query. The operations include generating, using a machine-learned embedding generation model, a text embedding for the text query. The operations include performing a similarity search for the text embedding with respect to a plurality of chunk embeddings respectively generated by the machine-learned embedding generation model for a plurality of document chunks of a plurality of documents, wherein the similarity search identifies as semantically similar to the text query one or more identified document chunks of the plurality of document chunks. The operations include generating a prompt that comprises the one or more identified document chunks. The operations include providing the prompt as an input to and for processing by a machine-learned large language model. The operations include receiving a language output generated by the machine-learned large language model based on the processing of the prompt. The operations include providing the language output as an output.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs optimization of user interactions and task selection for large language models according to example embodiments of the present disclosure.

FIG. 1B depicts a block diagram of an example computing device that performs semantic exploration of a specified subset of a plurality of documents according to example embodiments of the present disclosure.

FIG. 1C depicts a block diagram of an example computing device that performs facilitation of selection of particular language tasks to enhance user interactions with large language models according to example embodiments of the present disclosure.

FIG. 2 depicts a block diagram of an example machine-learned large language model according to example embodiments of the present disclosure.

FIG. 3 depicts a block diagram of an example machine-learned language model ensemble according to example embodiments of the present disclosure.

FIG. 4 depicts an example user interface for facilitating interactions between a user and a large language model according to some implementations of the present disclosure.

FIG. 5A depicts a user interaction with the example user interface of FIG. 4 assign documents to document subsets according to some implementations of the present disclosure.

FIG. 5B depicts a user interaction with the example user interface of FIG. 4 to assign documents to document subsets according to some other implementations of the present disclosure.

FIG. 6A depicts a user interaction with the example user interface of FIG. 4 to select a document subset from a plurality of document subsets according to some implementations of the present disclosure.

FIG. 6B depicts a user interaction with the example user interface of FIG. 4 to provide a query via a query field according to some implementations of the present disclosure.

FIG. 7A depicts user interactions with a large language model using an example user interface to request performance of a summarization task by the model according to some implementations of the present disclosure.

FIG. 7B depicts additional user interactions with a large language model using an example user interface to request performance of an oppositional viewpoint task by the model according to some implementations of the present disclosure.

FIG. 7C depicts additional user interactions with a large language model using an example user interface to request performance of a brainstorming task by the model according to some implementations of the present disclosure.

FIG. 7D depicts additional user interactions with a large language model using an example user interface to request performance of a simplification task by the model according to some implementations of the present disclosure.

FIG. 8 depicts various interface layouts in which the interfaces of previous figures can be implemented according to some implementations of the present disclosure.

FIG. 9 depicts a flow chart diagram of an example method to perform semantic exploration of a specified subset of a plurality of documents according to example embodiments of the present disclosure.

FIG. 10 depicts a flow chart diagram of an example method to perform large language model interactions with improved explainability according to example embodiments of the present disclosure.

FIG. 11 depicts a flow chart diagram of an example method to perform facilitation of selection of particular language tasks to enhance user interactions with large language models according to example embodiments of the present disclosure.

FIG. 12 depicts a flow chart diagram of an example method to perform dynamic selection of tasks for a large language model according to example embodiments of the present disclosure according to example embodiments of the present disclosure.

Reference numerals that are repeated across plural figures are intended to identify the same features in various implementations.

### DETAILED DESCRIPTION

### Overview

Generally, the present disclosure is directed to optimizing task performance with large language models. More particularly, the present disclosure relates to optimizing interactions between users and large language models while selecting tasks for the large language models. As an example, a computing system can obtain a text query from a user. The text query can be processed with a machine-learned embedding generation model to generate a text embedding of the query. This query can be used to access a plurality of chunk embeddings within an embedding space. The chunk embeddings can each correspond to various chunks of documents, which can be organized in various document subsets. For example, a user can collect ten various types of documents (e.g., articles, patent documents, research papers, websites, etc.) and sort them by type into document subsets (e.g., if four of the ten documents are patent documents, they can be sorted into their own document subset).

The computing system can obtain data indicating that the user has selected one of the document subsets. The computing system can then perform a similarity search between the query embedding and only those chunk embeddings associated with chunks of documents included in the selected document subset to identify one or more identified document chunks.

In some implementations, the identified document chunk(s) can be directly provided to the user within a user interface. For example, the user may be interacting with a word processing application, and the identified document chunk(s) can be provided within the margins of a word document. For another example, the identified document chunk(s) can be provided within some interface, and can include attribution information (e.g., citations, etc.) that indicate a location of each document chunk within their respective documents.

Additionally, or alternatively, in some implementations, the computing system can utilize the identified document chunk(s) as an input for a large language model to provide more information to the user. For example, the computing system can generate a prompt that includes the identified document chunk(s). The computing system can provide the prompt as an input to a machine-learned large language model (e.g., can process the prompt with the model, can provide the prompt to a remote service that implements the model, etc.) to receive a language output generated by the model. The language output can be provided to the user.

In some implementations, the user can specify a particular task for the machine-learned large language model to perform. For example, the user interface can include a variety of selectable task elements that correspond to specific tasks performable by the machine-learned large language model (e.g., a simplification task, summarization task, oppositional viewpoint task, etc.). The computing system can obtain information indicating that the user has selected one of the task elements. The computing system can then perform the task that corresponds to the task element using the machine-learned large language model to obtain a large language output that fulfills the task. For a specific example, the computing system can obtain information indicating that the user has selected a summarization task. The computing system can process the identified document chunk(s) with the machine-learned large language model to obtain a language output. The computing system can then then use the machine-learned large language model to generate a summarization output that summarizes the language output. Alternatively, rather than generating the language output, the computing system can generate an initial language output that summarizes the identified document chunk(s).

Alternatively, in some implementations, the computing system can automatically determine which task to select for performance by the machine-learned large language model. For example, the computing system can identify the identified document chunk(s), and can determine that the identified document chunk(s), and/or the text query from the user, represent a particular viewpoint. Based on the identified document chunk(s) and/or the text query, the computing system can select an oppositional viewpoint task. The computing system can then use the machine-learned large language model to generate a language output descriptive of a viewpoint opposite to that expressed by the identified document chunk(s) and/or the text query. In such fashion, the computing system can facilitate interactions between the user and the machine-learned large language model to optimize delivery of information to the user.

Aspects of the present disclosure provide a number of technical effects and benefits. As one example technical effect and benefit, users of conventional search processes, word processing applications, etc. often must spent substantial quantities of time and effort navigating between references, analyzing references, studying background information to comprehend difficult concepts, etc. However, by optimizing interactions between users and machine-learned large language models, and facilitating model task selection, implementations of the present disclosure can substantially reduce the time spent by users using computing devices to conduct research. For example, rather than a user spending hours manually searching through complex academic papers for information, implementations of the present disclosure can optimize interactions between the user and the large language model such as to provide the user with the same information in a matter of minutes. In turn, this eliminates the expenditure of substantial quantities of compute resources that a user would otherwise use (e.g., compute cycles, power, memory, etc.). Further, by reducing the time expense of users, implementations of the present disclosure can increase efficiency across a number of use-cases (e.g., software engineering, medical research, citing documents for research papers, etc.).

With reference now to the Figures, example embodiments of the present disclosure will be discussed in further detail.

### Example Devices and Systems

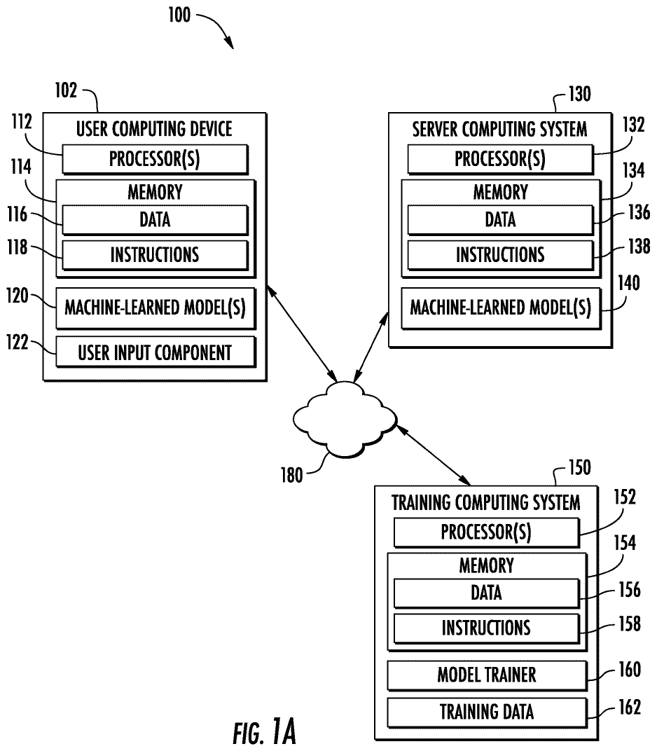

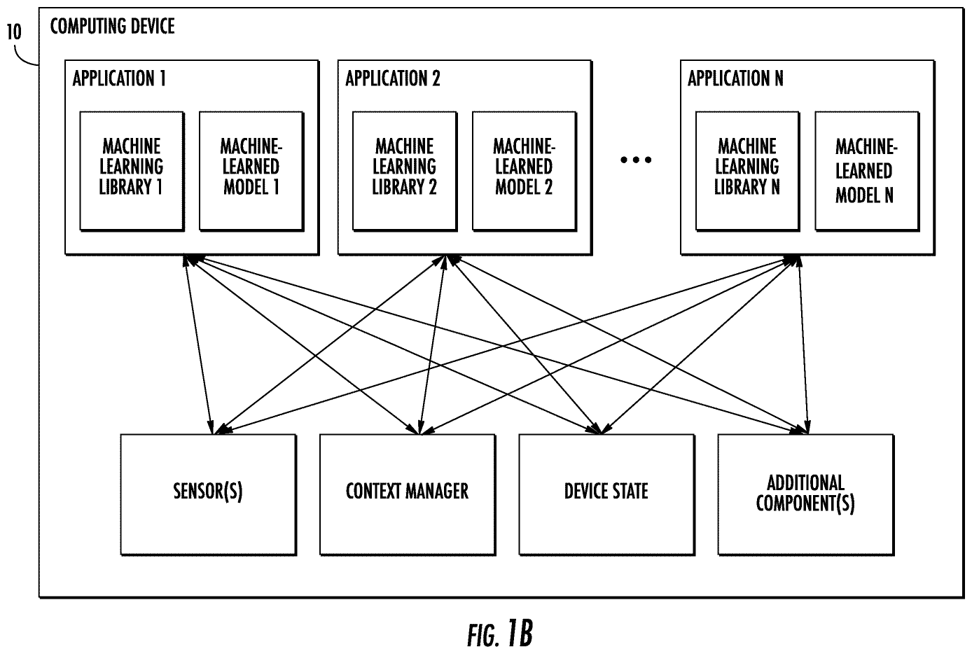

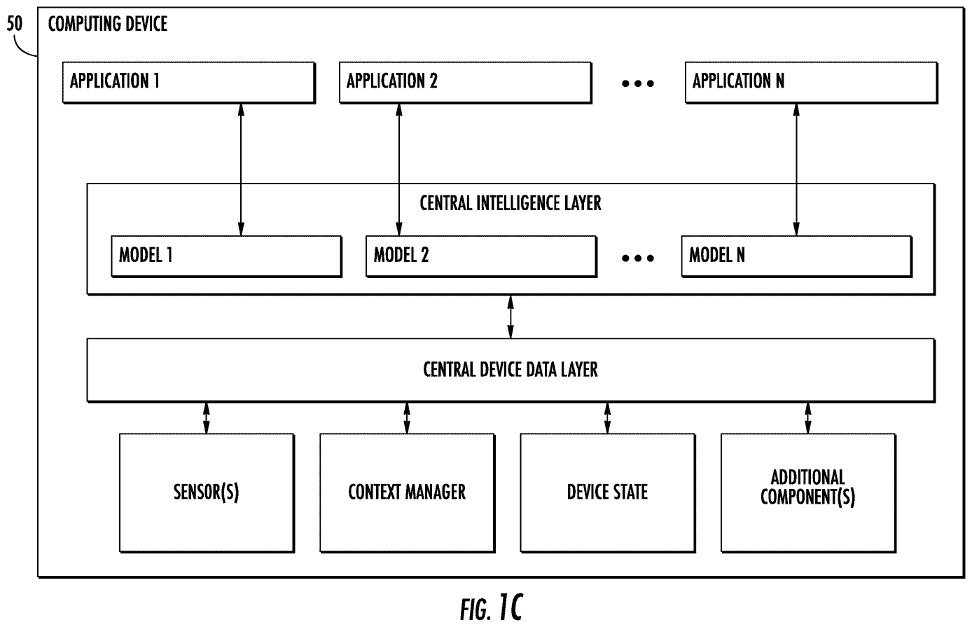

FIG. 1A depicts a block diagram of an example computing system 100 that performs optimization of user interactions and task selection for large language models according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

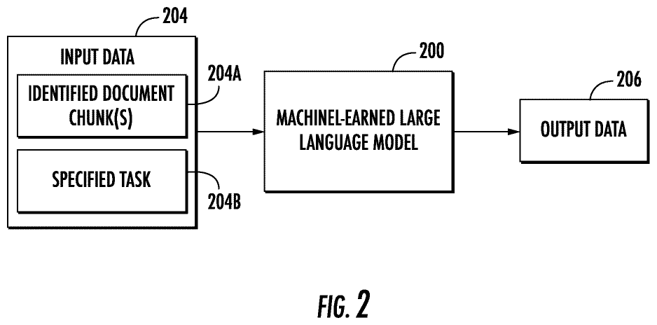

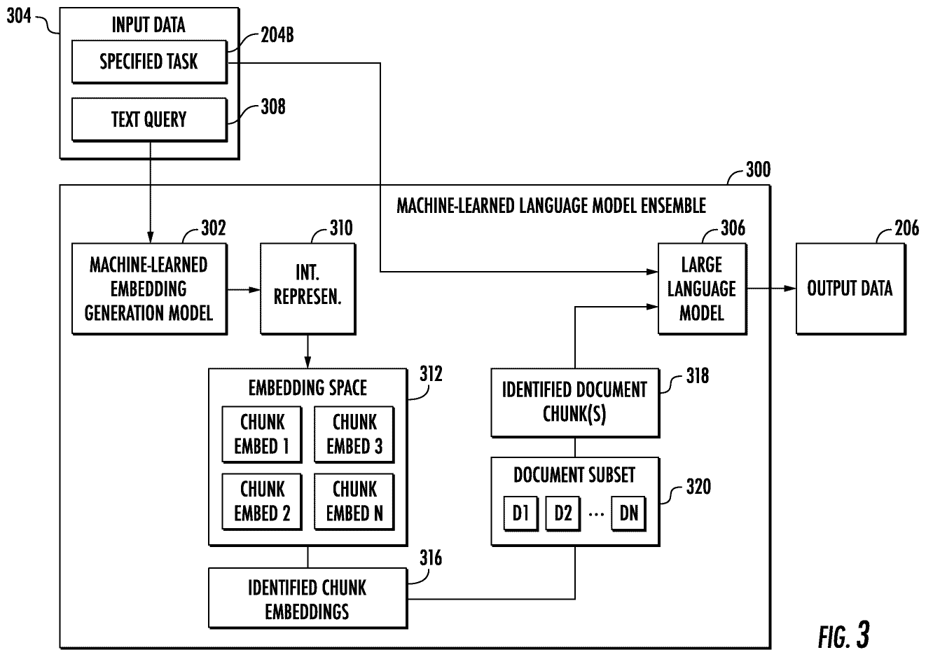

In some implementations, the user computing device 102 can store or include one or more models 120. For example, the models 120 can be or can otherwise include various machine-learned models such as neural networks (e.g., deep neural networks), large language models (LLMs) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example models 120 are discussed with reference to FIGS. 2 and 3.

In some implementations, the one or more models 120 can be received from the server computing system 130 over network 180, stored in the user computing device memory 114, and then used or otherwise implemented by the one or more processors 112. In some implementations, the user computing device 102 can implement multiple parallel instances of a single model 120 (e.g., to perform parallel optimization of user interactions and task selection for large language models across multiple instances of the models 120).

More particularly, model(s) 120 can, in some implementations, include a machine-learned embedding generation model. The machine-learned embedding generation model can be any type or manner of model or models (e.g., a model architecture including multiple models) sufficient to generate an intermediate representation of a query. In some implementations, the query can be a text query, and the machine-learned embedding generation model can generate a text embedding of the text query. Alternatively, in some implementations, the query can be an image query, video query, gesture query, contextual query (e.g., a query that includes contextual information (e.g., location, pose, environment, time, etc.), multimodal query (e.g., text and image inputs, etc.), etc.), and the machine-learned embedding generation model can generate an intermediate representation (e.g., an embedding) of the query.

Additionally, or alternatively, in some implementations, the model(s) 120 can include a machine-learned large language model. The machine-learned large language model can be, or otherwise include, a model that has been trained on a large corpus of language training data in a manner that provides the machine-learned large language model with the capability to perform multiple language tasks. For example, the machine-learned large language model can be trained to perform summarization tasks, conversational tasks, simplification tasks, oppositional viewpoint tasks, etc. In particular, the machine-learned large language model can be trained to process a variety of outputs to generate a language output. For example, the machine-learned large language model can process an embedding generated by the machine-learned embedding generation model, document chunk(s) identified using the embedding generation model, language outputs generated using the machine-learned large language model or some other model, etc.

Additionally or alternatively, one or more models 140 can be included in or otherwise stored and implemented by the server computing system 130 that communicates with the user computing device 102 according to a client-server relationship. For example, the models 140 can be implemented by the server computing system 130 as a portion of a web service (e.g., a word processing service, etc.). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 2 and 3.

In particular, the model(s) 140 of the server computing system 130 can include some, or all, of the model(s) 120 included in the user computing device 102, and can provide such models as a service for the user computing device 102. For example, in some implementations, the model(s) 140 can include a machine-learned embedding generation model. The server computing system 130 can also maintain an embedding space that includes embeddings generated using the machine-learned embedding generation model. The user computing device 102 can provide a query to the server computing system 130, and the server computing system 130 can process the query with the machine-learned embedding generation model to obtain an intermediate representation of the query.

In some implementations, the server computing system 130 can return the intermediate representation of the query to the user computing device 102. Alternatively, in some implementations, the machine-learned model(s) 140 can include a machine-learned large language model, and the server computing system 130 can process the intermediate representation with the machine-learned large language model to obtain a language output. The language output, or information that is indicative or otherwise descriptive of the language output, can be provided to the user computing device 102.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the models 120 and/or 140 based on a set of training data 162. The training data 162 can include, for example, a corpus of

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs semantic exploration of a specified subset of a plurality of documents according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs facilitation of selection of particular language tasks to enhance user interactions with large language models according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Model Arrangements

FIG. 2 depicts a block diagram of an example machine-learned large language model 200 according to example embodiments of the present disclosure. In some implementations, the machine-learned large language model 200 is trained to receive a set of input data 204 that is, or otherwise describes, identified document chunk(s) and, as a result of receipt of the input data 204, provide output data 206 that is descriptive of a language output.

In some implementations, the input data 204 can further indicate a particular task of a plurality of tasks performable by the machine-learned large language model 200. For example, the input data 204 can include identified document chunk(s) 204A, and can indicate a summarization task 204B. The machine-learned large language model 200 can process the input data 204 to generate output data 206 descriptive of a language output that summarizes the identified document chunk(s).

FIG. 3 depicts a block diagram of an example machine-learned language model ensemble 300 according to example embodiments of the present disclosure. The machine-learned language model 300 ensemble includes a machine-learned embedding generation model 302 and a large language model 306, which is similar to the machine-learned large language model 200 of FIG. 2 except that the large language model 306 is included within the machine-learned language model ensemble 300 alongside the machine-learned embedding generation model 302.

As an example, input data 304 can include specified task 204B of FIG. 2 and a text query 308. The text query 308 can be a query to the machine-learned language model ensemble from a user. The machine-learned embedding generation model 302 can process the text query 308 to obtain an intermediate representation 310 of the text query 308. The intermediate representation 310 can be utilized to perform a search of an embedding space 312 that includes embeddings generated by the machine-learned embedding generation model 302. The embeddings are embeddings of chunks of documents organized in a subset of documents 314.

Specifically, the machine-learned embedding generation model 302 can process intermediate representation 310 to identify chunk embedding(s) 316 that are semantically similar to the text query 308. Identified document chunk(s) 318 can then be retrieved from the subset of document(s) 320. The identified document chunk(s) 318 are chunk(s) of the documents of the subset of document(s) 320 that correspond to the identified chunk embedding(s) 316.

The large language model 306 can process the identified document chunk(s) 318 to generate output data 206 descriptive of a language output. In some implementations, the large language model 306 can also process, or otherwise be adjusted based on the specified task 204B. For example, the specified task 204B can be a summarization task. The large language model 306 can be adjusted to perform the summarization task based on the specified task 204B. The large language model 306 can then process the identified document chunk(s) 318 to generate output data 206, which can describe a language output that includes a summarization of the identified document chunk(s) 318.

### Example Implementations

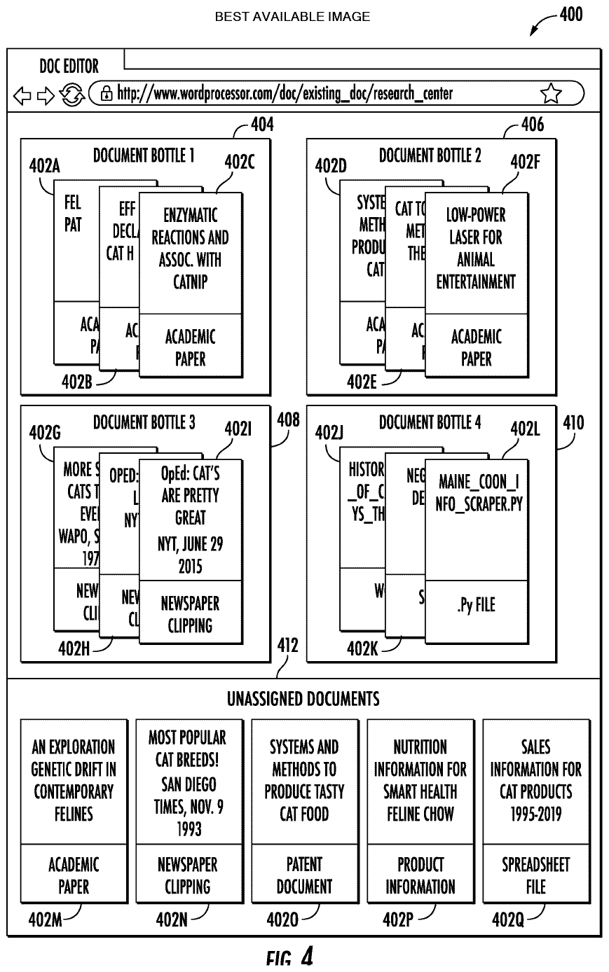

FIG. 4 depicts an example user interface 400 for facilitating interactions between a user and a large language model according to some implementations of the present disclosure. Specifically, the interface 400 can be an interface for a word processing application (e.g., a web application. The interface 400 can include a plurality of documents 402A-402Q (generally, documents 402). Some of the documents 402 can be organized into document subsets 404, 406, 408, and 410. Other documents 402 can be unassigned. To follow the depicted example, a first document subset 404 (e.g., document bottle 1) can a subset of academic papers, and can include documents (e.g., academic paper documents) 402A, 402B, and 402C. A second document subset 406 can be a subset of patent documents, and can include documents (e.g., patent documents) 402D, 402E, and 402F. A third document subset 408 can be a subset of newspaper articles or clippings documents, and can include documents (e.g., newspaper clippings) 402G, 402H, and 402I. A fourth document subset 410 can be a subset of files (e.g., files of programmatic instructions, slide deck files, word processor files, spreadsheet files, etc.), and can include documents (e.g., files) 402J, 402K, and 402L. The interface 400 can include an unassigned documents section 412 that includes unassigned documents 402M, 402N, 4020, 402P, and 402Q.

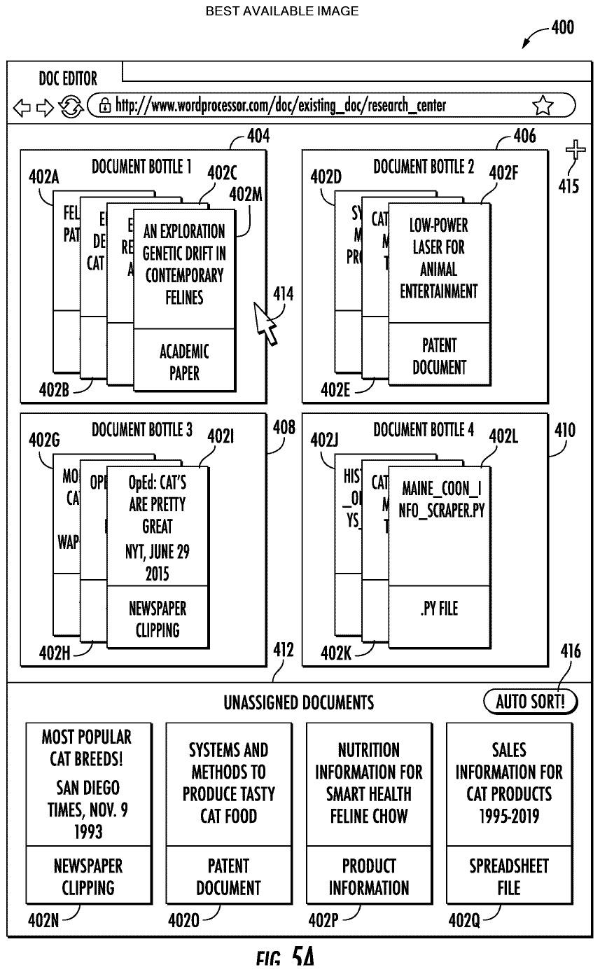

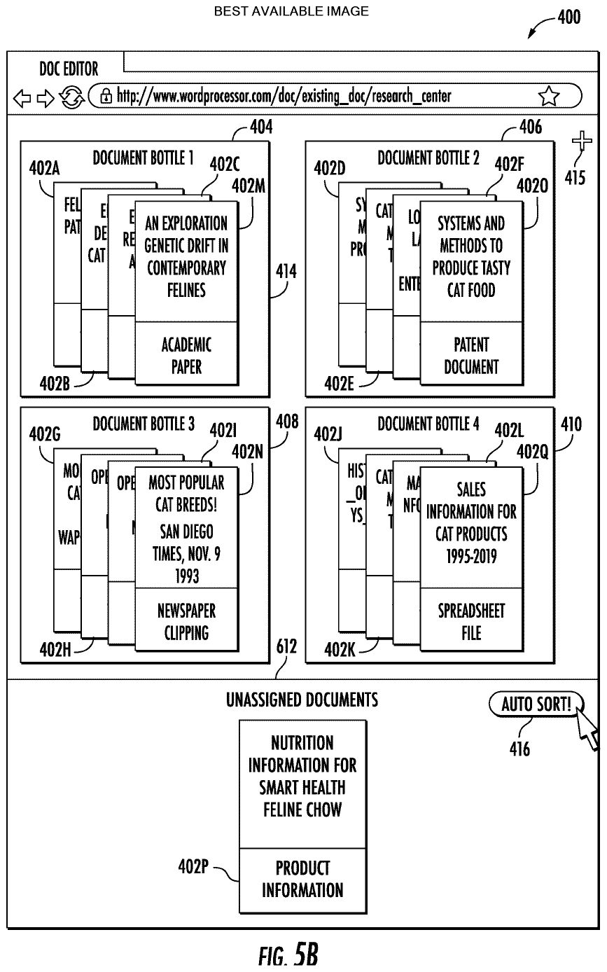

FIG. 5A depicts a user interaction with the example user interface 400 of FIG. 4 assign documents to document subsets according to some implementations of the present disclosure. Specifically, at FIG. 5A, a user has manually assigned document 402M to the document subset 404. More specifically, the user has used an input device (e.g., a mouse, a trackpad, etc.) to manipulate a cursor to drag the document 402M to the document subset 404 that is associated with academic papers. The user can manually assign each of the documents 402M-402Q to the document subsets 404-410 to which they should be assigned. For example, the user can manually assign document 402N to document subset 408, document 4020 to document subset 406, and document 402Q to document subset 410.

Document 402P represents a document that does not directly correspond to an existing document subset. In some implementations, the user can create a new document subset using document subset creation element 415. In some implementations, the user can associate a particular type of document to the newly created document subset. For example, the user can associate the newly created document subset with product information documents, and can then assign document 402P to the newly created document subset. For another example, the user can first assign the document 402P to the newly created document subset, and a computing system implementing the interface 400 can create an association between the newly created document subset and product information documents.

FIG. 5B depicts a user interaction with the example user interface 400 of FIG. 4 to assign documents to document subsets according to some other implementations of the present disclosure. Specifically, at FIG. 5B, the user has provided a selection input to sorting element 416. Sorting element 416 causes the computing system implementing the interface 400 to automatically sort the unassigned documents 402M-402Q to existing document subsets 404-410. In some implementations, the computing system can sort the unassigned documents 402M-402Q by determining a document type for each of the documents. For example, the computing system can determine that document 402M is an academic paper, and thus should be assigned to the document subset 404 that is associated with academic papers. For another example, the computing system can determine that document 402N is a newspaper clipping, and thus should be assigned to the document subset 408 that is associated with newspaper clippings.

Alternatively, in some implementations, the computing system can assign the unassigned documents 402M-402Q to existing document subsets 404-410 based on some other metric or heuristic. For example, the computing system can determine a semantic understanding of each document (e.g., whether the “tone” of a document is generally negative or positive) and can assign the unassigned documents 402M-402Q based on the determined semantic understanding. For another example, the computing system can assign one of the unassigned documents 402M-402Q based on multiple determinations. For example, if document subset 406 is for positive newspaper clippings, and document subset 408 is for negative newspaper clippings, the computing system can first determine that document 402N is a newspaper clipping can then determine that the newspaper clipping is semantically negative, and thus should be assigned document subset 408.

More generally, it should be broadly understood that the computing system can assign the documents to the document subsets 408 based on any type or manner of criteria (e.g., title, subject matter, semantic understanding, length, date of publication, public accessibility, relevance, file type, etc.). In some implementations, document subsets and types of documents can be associated with varying degrees of specificity. For example, the computing system can maintain a relatively strict association between document subset 404 and academic paper type documents, and maintain a relatively relaxed association between document subset 408 and newspaper clipping type documents. Based on these maintained associations, the computing system may determine to refrain from assigning document 402P to the document subset 404 (e.g., due to the strict association between the subset and academic paper document types) and instead assign the document 402P to the document subset 408 (e.g., due to the relaxed association between the subset and newspaper clipping document types).

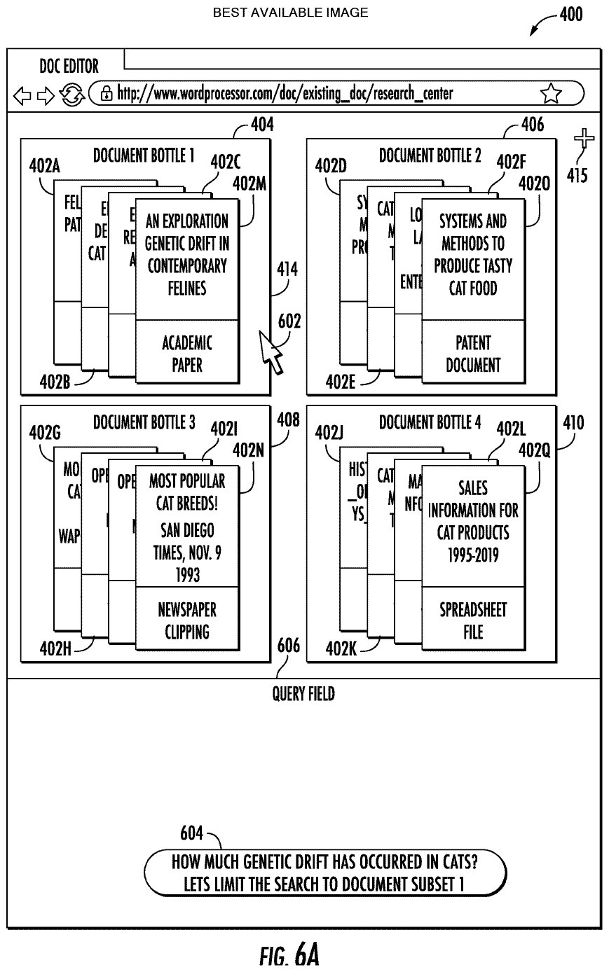

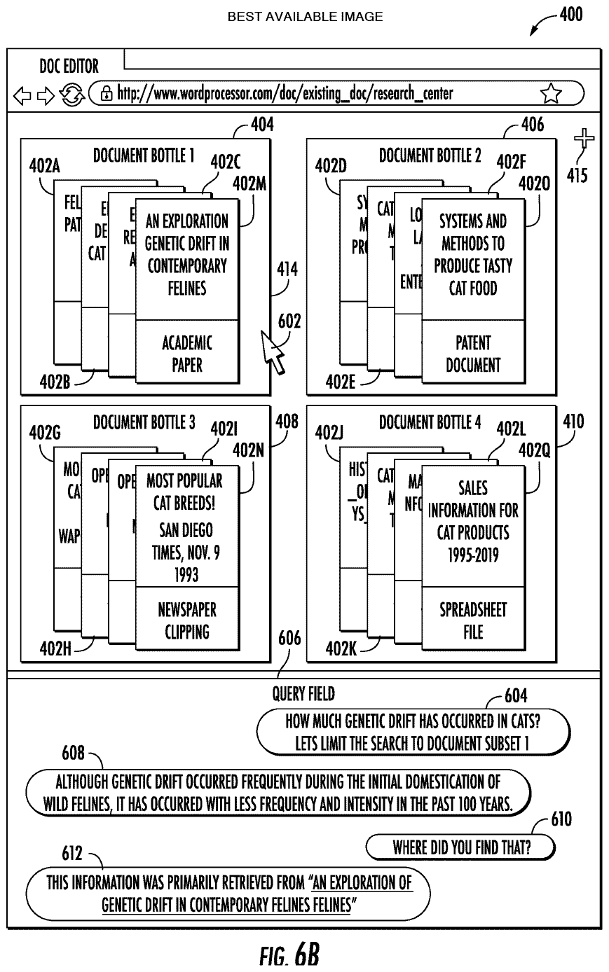

FIG. 6A depicts a user interaction with the example user interface 400 of FIG. 4 to select a document subset from a plurality of document subsets according to some implementations of the present disclosure. Specifically, in some implementations, the user can provide a cursor input 602 that selects document subset 404. Alternatively, in some implementations, the user can provide a query 604 within a query field 606. The query field 606 can allow the user to provide queries to the computer system via the interface 400. Specifically, as depicted, the user can provide a query 604 to the computing system within query field 606 that asks “how much genetic drift has occurred in cats?” and instructs the computing system to determine this information based on documents assigned to the document subset 404.

FIG. 6B depicts a user interaction with the example user interface 400 of FIG. 4 to provide a query via a query field according to some implementations of the present disclosure. Specifically, the query field 604 can be utilized to facilitate interactions between the user and a large language model (e.g., machine-learned large language model 200 of FIG. 2, etc.). To follow the depicted example, the user can provide the query described with regards to FIG. 6A. The computing system can process the query 604 to obtain an output 608. In some implementations, the computing system can process the query 604 with a machine-learned embedding model (e.g., as described with regards to FIG. 3) to identify document chunk(s) semantically similar to the query 604, and can return the chunk(s) as output 608. Alternatively, in some implementations, the computing system can process the identified document chunk(s) with a machine-learned large language model (e.g., as described with regards to FIG. 3) to obtain an output 608 that includes a language output.

The computing system can provide the output 608 for display within the query field 606 of the interface 400. The user can provide a second query 610 within the query field 604 and the computing system can process the second query 610 in the same manner to generate a second output 612 for display within the query field 606. Additionally, in some implementations, the computing system can provide attribution information 614 for display within the interface 400. The attribution information 614 can identify document(s) that the language output 612 is based on. In some implementations, if the output 612 includes specific document chunk(s) from a document 402, the attribution information 614 can describe a specific location of the identified document chunk within the document 402 from which it originates. For example, the attribution information 614 can be or otherwise describe a citation in a particular citation format that identifies the location of the document chunk (e.g., MLA, Chicago style, Blue Book, etc.). For another example, the attribution information 614 can include a link that, when selected by the user, navigates the user to the location within the document from which the document chunk originates.

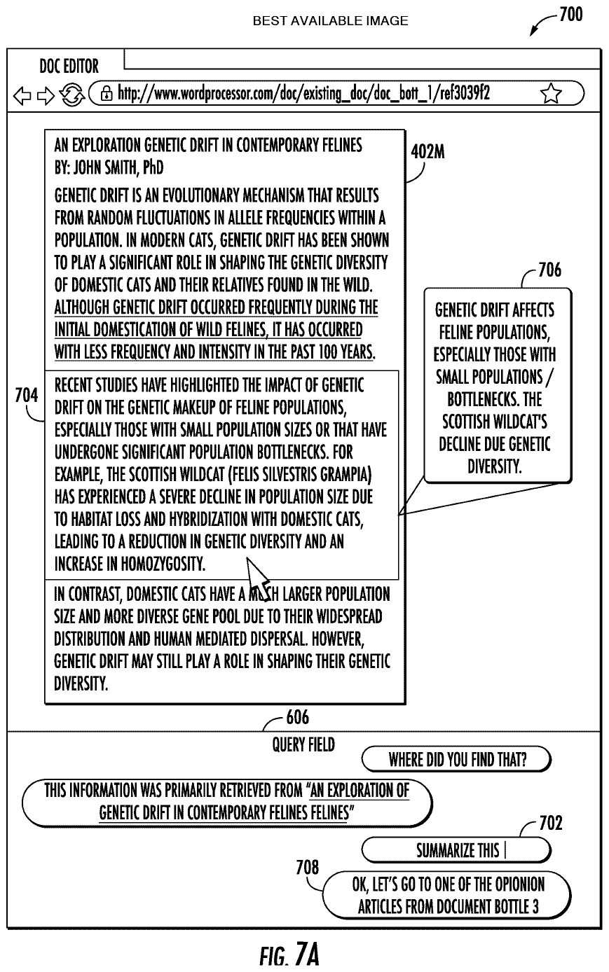

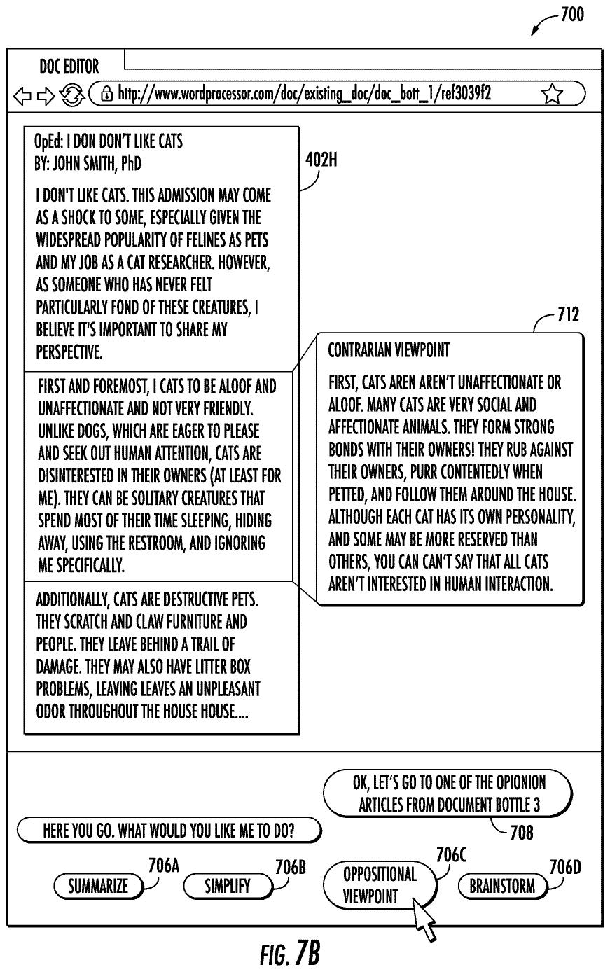

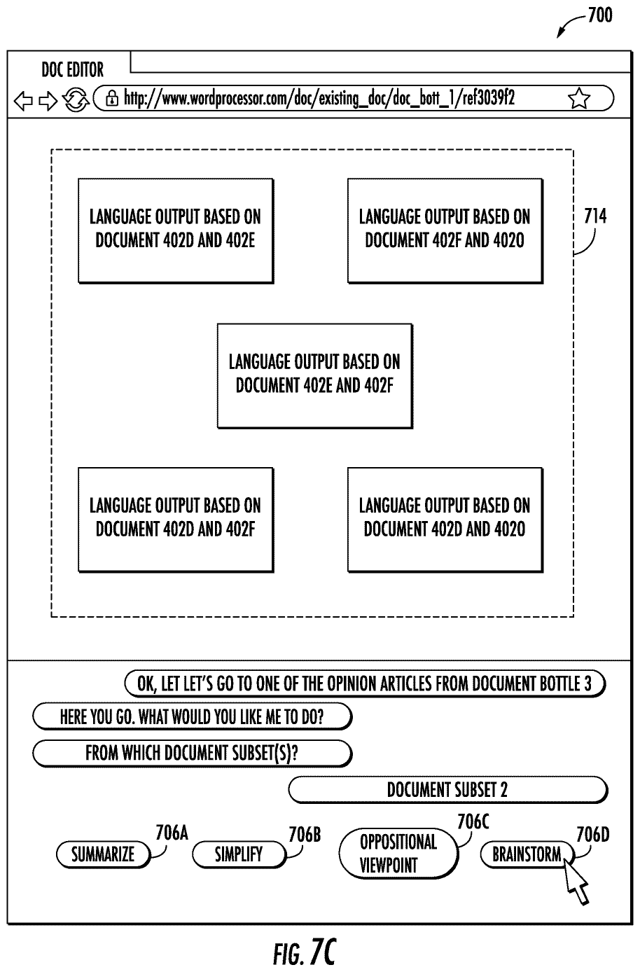

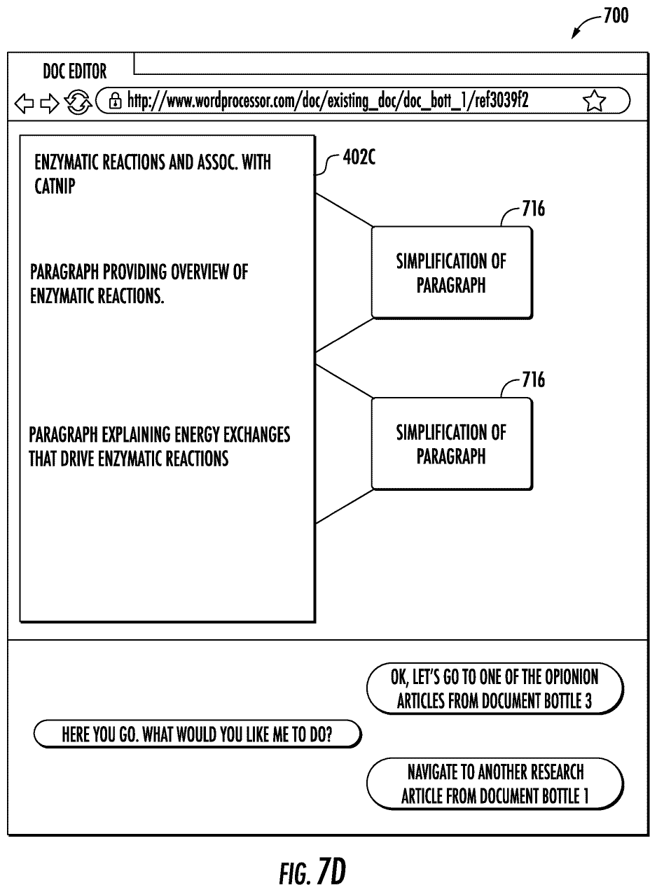

FIG. 7A depicts user interactions with a large language model using an example user interface 700 to request performance of a summarization task by the model according to some implementations of the present disclosure. Specifically, the interface of FIG. 7A can be presented in response to the user's selection of the selectable link included in the attribution information 614 as described with regards to FIG. 6B. The interface 700 displays document 402M from document subset 404 responsive to the user's selection of the selectable link. Once the document 402M is displayed, the interface 700 can facilitate further interactions between the user and the large language model. For example, the user can provide a query 702 that requests performance of a summarization task. Specifically, the query 702 includes a textual query from the user (e.g., “summarize this”) alongside an identified (i.e., highlighted) document chunk 704. The computing system can process the query 702 with the machine-learned embedding model to obtain an embedding of the query, and can process the embedding of the query with the machine-learned large language model to obtain a language output 706. The language output 706 can summarize the identified document chunk 704.

The user can provide an additional query 708 that instructs the computing system to navigate to a different document. The computing system can process the query 708 to determine the instruction to navigate to the different document. For example, the computing system can process the query 708 with the machine-learned large language model to determine the instruction.

FIG. 7B depicts additional user interactions with a large language model using an example user interface 700 to request performance of an oppositional viewpoint task by the model according to some implementations of the present disclosure. Specifically, the interface 700 of FIG. 7B can include document 402H responsive to the query 708 described in FIG. 7A. In some implementations, in addition to displaying the document 402H, the computing system can provide a variety of task elements 710 that each correspond to a specific task performable by the machine-learned large language model. For example, the task element 710A corresponds to performance of the summarization task described with regards to FIG. 7A. The task element 710B corresponds to performance of a simplification task. The task element 710C corresponds to performance of an oppositional viewpoint task (i.e., a “contrarian” opinion). Finally, the task element 710D corresponds to a brainstorming task.

The user can select task element 710C. In response, the computing system can perform an oppositional viewpoint task using the machine-learned large language model to generate language output 712. The language output 712 can describe an opinion contrary to the opinion expressed by the document 402H (or the relevant identified document chunk(s) of document 402H). To follow the depicted example, the user can select the oppositional viewpoint element 706C and select (e.g., highlight, etc.) a document chunk from the document 402H. The computing system can process the document chunk to perform the oppositional viewpoint task to generate a language output 712 that describes a viewpoint opposite that of the viewpoint expressed in the document chunk. In some implementations, the computing system may make a determination that textual content expresses an opinion, and based on the determination, may select an oppositional view task for the machine-learned large language model.

FIG. 7C depicts additional user interactions with a large language model using an example user interface 700 to request performance of a brainstorming task by the model according to some implementations of the present disclosure. Specifically, as depicted in FIG. 7C, the user can select a brainstorming task 706D. In some implementations, the computing system can inquire as to with which document subset to perform the brainstorm task. For example, the user can specify that they wish the brainstorm to be performed based on document subset 2 (e.g., the document subset 406 associated with patent documents). In response, the computing system can generate a plurality of language outputs 714 and display the language outputs 714 to the user within the interface 700. The language outputs 714 can each be generated iteratively based on different identified documents, document chunk(s), combinations of identified document chunks, etc.

FIG. 7D depicts additional user interactions with a large language model using an example user interface 700 to request performance of a simplification task by the model according to some implementations of the present disclosure. Specifically, in some implementations, rather than selecting a task element, the computing system can automatically determine to perform a particular task using the machine-learned large language model. For example, the computing system can determine a complexity metric descriptive of a degree of complexity associated with identified chunks of the document 402C (e.g., a term frequency-inverse document frequency (TF-IDF) metric, a metric generated using a complexity classification model, etc.). Based on making a determination that the complexity metric is greater that a threshold degree of complexity, the computing system can select a simplification task of the plurality of task for the machine-learned large language model. The computing system can process the identified document chunks from document 402C with the machine-learned large language model to generate language output 716 that is a simplified language output that simplifies the identified document chunks. In some implementations, the computing system can replace a language output with the simplified language output within the user interface.

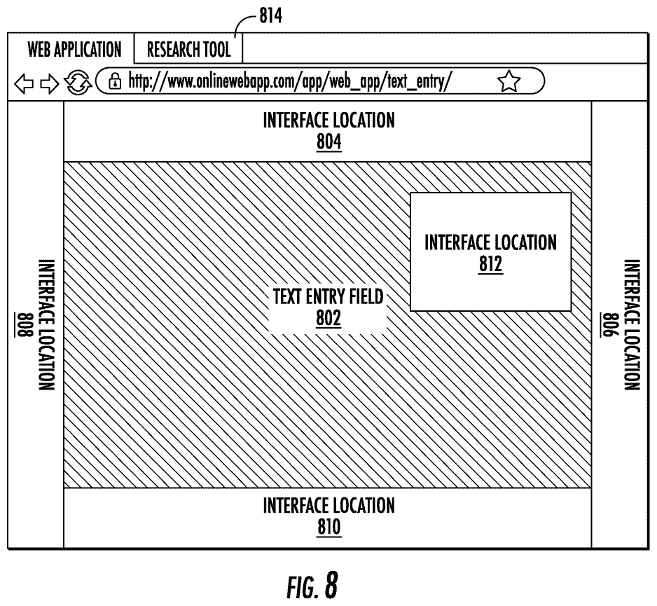

FIG. 8 depicts various interface layouts in which the interfaces of previous figures can be implemented according to some implementations of the present disclosure. More generally, it should be broadly noted that the interfaces described with regards to FIG. 4-FIG. 7D are illustrated only to demonstrate the manner in which user interaction with a large language model can be facilitated. However, such interfaces may be implemented using any type or manner of layout, design, interface elements, application(s), etc.

As a particular example, FIG. 8 illustrates an interface for a web application in which a user can enter data in a text-editing interface 802. For example, the text-editing interface 802 can be an interface for a word processing application that allows users to enter textual content into the word processing application. For another example, the text-editing interface 802 can be an interface that allows a user to enter text into a spreadsheet application, slide deck application, calendar application, instant messaging application, database application, social media application, gaming application, etc.

In some implementations, the interfaces of FIGS. 4-7D can be located within some, or all, of the interface locations 804, 806, 808, 810, and 812. For example, the interface 400 of FIGS. 4-6B can be located within the interface location 806 (e.g., to allow the user to manipulate document subsets by adding, removing, reordering documents, etc.). The interface 700 of FIGS. 7A-7D can be implemented in any of the interface locations 804, 808, 810, and 812, or can be distrusted amongst multiple interface locations.

As a particular example, the query field 606 of FIG. 6A can be implemented in the interface location 810. Language outputs from the machine-learned large language model can be presented and stored/indexed in the interface location 808. Identified document chunks from the documents managed at interface location 806 can be retrieved and displayed to the user within the interface location 804. Additional settings for each of these interface implementations can be modified within a separate interface accessible from the interface location 814 (e.g., a separate tab from the current interface.

Accordingly, it should be broadly understood that implementations of the present disclosure are not limited to specific interface implementations illustrated herein. Rather, implementations described herein that facilitate semantic exploration of a specified subset of a documents, large language model interactions with improved explainability, selection of particular language tasks to enhance user interactions with large language models, and/or dynamic selection of tasks for a large language model can be implemented using any type or manner of user interface.

### Example Methods

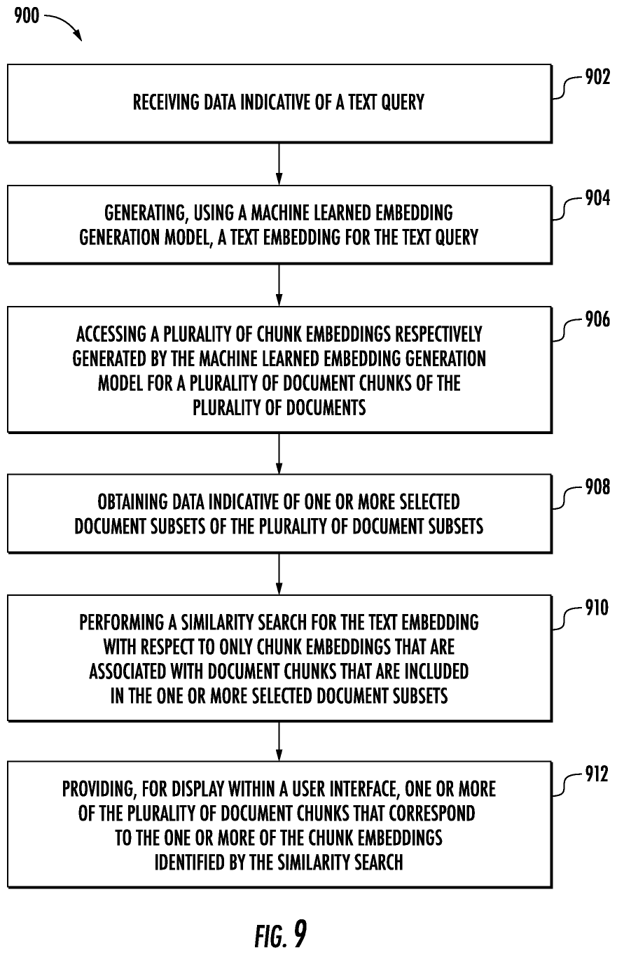

FIG. 9 depicts a flow chart diagram of an example method 900 to perform semantic exploration of a specified subset of a plurality of documents according to example embodiments of the present disclosure. Although FIG. 9 depicts steps performed in a particular order for purposes of illustration and discussion, the methods of the present disclosure are not limited to the particularly illustrated order or arrangement. The various steps of the method 900 can be omitted, rearranged, combined, and/or adapted in various ways without deviating from the scope of the present disclosure.

At 902, a computing system that includes one or more computing devices can receive data indicative of a text query.

At 904, the computing system can generate, using a machine-learned embedding generation model, a text embedding for the text query At 906, the computing system can access a plurality of chunk embeddings respectively generated by the machine-learned embedding generation model for a plurality of document chunks of the plurality of documents. The plurality of documents can be organized into a plurality of document subsets.

At 908, the computing system can obtain data indicative of one or more selected document subsets of the plurality of document subsets. In some implementations, the one or more selected document subsets are specified by the user. In some implementations, at least some of the documents included in the one or more selected document subsets comprise documents supplied by the user. In some implementations, at least some of the documents included in the one or more selected document subsets comprise books, product manuals, legal opinions, academic papers, proprietary data files, patents documents, or any other type or manner of document (e.g., a web page, email, forum post, social media post, video, image, etc.).

At 910, the computing system can perform a similarity search for the text embedding with respect to only chunk embeddings that are associated with document chunks that are included in the one or more selected document subsets, wherein the similarity search identifies one or more of the chunk embeddings as semantically similar to the text query.

At 912, the computing system can provide, for display within a user interface, one or more of the plurality of document chunks that correspond to the one or more of the chunk embeddings identified by the similarity search. In some implementations, the user interface includes a text-editing interface associated with a word processing application. In some implementations, the user interface includes a primary text-editing field that enables a user of the user interface to generate a set of text, and the text query comprises at least a portion of the set of text generated by the user through interaction with the primary text-editing field. In some implementations, the user interface includes a primary text-editing field that enables the user to generate a set of text and a query field, separate from the primary text-editing field, that enables the user to enter the text query separate from the set of text.

In some implementations, the user interface comprises a document subset selection tool that enables the user to provide a user input to select the one or more selected document subsets from the plurality of document subsets. In some implementations, the document subset selection tool provides a graphical representation of the plurality of document subsets. In some implementations, the document subset selection tools enables the user to apply a set of filter logic to the plurality of document subsets, wherein application of the filter logic selects the one or more selected document subsets from the plurality of document subsets.

In some implementations, the computing system obtains the plurality of documents, parses the plurality of documents into the plurality of document chunks, and generates, using the machine-learned embedding generation model, the plurality of chunk embeddings.

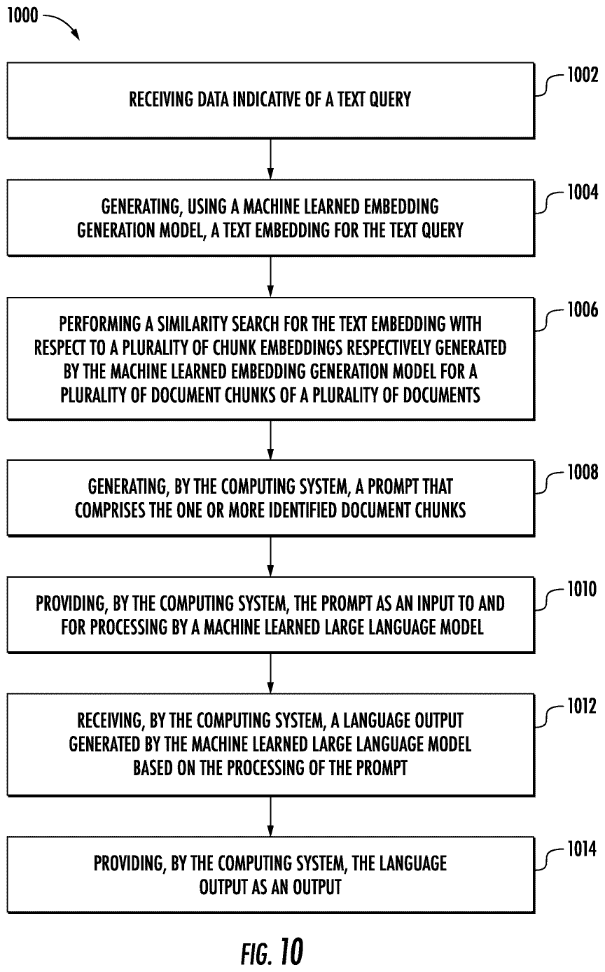

FIG. 10 depicts a flow chart diagram of an example method 1000 to perform large language model interactions with improved explainability according to example embodiments of the present disclosure. Although FIG. 10 depicts steps performed in a particular order for purposes of illustration and discussion, the methods of the present disclosure are not limited to the particularly illustrated order or arrangement. The various steps of the method 1000 can be omitted, rearranged, combined, and/or adapted in various ways without deviating from the scope of the present disclosure.

At 1002-1004, a computing system can receive data indicative of a text query and generate, using a machine-learned embedding generation model, a text embedding for the text query as described with regards to FIG. 9.

At 1006, the computing system can perform a similarity search for the text embedding with respect to a plurality of chunk embeddings respectively generated by the machine-learned embedding generation model for a plurality of document chunks of a plurality of documents. The similarity search identifies as semantically similar to the text query one or more identified document chunks of the plurality of document chunks.

In some implementations, prior to performing the similarity search for the text embedding with respect to the plurality of chunk embeddings respectively generated by the machine-learned embedding generation model for the plurality of document chunks of the plurality of documents, the computing system can access the plurality of chunk embeddings respectively generated by the machine-learned embedding generation model for the plurality of document chunks of the plurality of documents. The plurality of documents are organized into a plurality of document subsets. In some implementations, the computing system can obtain data indicative of one or more selected document subsets of the plurality of document subsets.

In some implementations, performing the similarity search for the text embedding comprises can include performing a similarity search for the text embedding with respect to only chunk embeddings that are associated with document chunks that are included in the one or more selected document subsets. The similarity search identifies as semantically similar to the text query one or more identified document chunks of the plurality of document chunks that are included in the one or more selected document subsets.

At 1008, the computing system generates a prompt that comprises the one or more identified document chunks.

At 1010, the computing system provides the prompt as an input to and for processing by a machine-learned large language model.

At 1012, the computing system receives a language output generated by the machine-learned large language model based on the processing of the prompt.

At 1014, the computing system provides the language output as an output. In some implementations, providing the language output as an output includes providing, by the computing system, the language output for display within a user interface associated with a word processing application. In some implementations, providing the language output for display within the user interface further comprises providing, by the computing system, attribution information for display within the user interface. The attribution information identifies a document of the one or more document subsets that includes an identified document chunk of the one or more identified document chunks. In some implementations, the attribution information is descriptive of a location of the identified document chunk within the document. In some implementations, the user interface comprises a primary text-editing field that enables a user of the user interface to generate a set of text. The text query comprises at least a portion of the set of text generated by the user through interaction with the primary text-editing field. In some implementations, the one or more selected document subsets are specified by the user.

In some implementations, the computing system can receive data indicative of a second text query comprising at least a portion of a second set of text generated by the user through interaction with the primary text-editing field. The second set of text is responsive to the language output.

In some implementations, the computing system can further generate, using the machine-learned embedding generation model, a second text embedding for the second text query. The computing system can perform a second similarity search for the second text embedding with respect to only chunk embeddings that are associated with document chunks that are included in one or more second document subsets of the plurality of document subsets. The second similarity search identifies as semantically similar to the second text query one or more second identified document chunks of the document chunks that are included in the one or more second document subsets. The computing system can generate a second prompt that comprises the one or more second identified document chunks. The computing system can provide the second prompt as an input to and for processing by the machine-learned large language model. The computing system can receive a second language output generated by the machine-learned large language model based on the processing of the second prompt. The computing system can provide the second language output for display within the user interface associated with the word processing application.

In some implementations, prior to performing the second similarity search for the second text embedding with respect to only the chunk embeddings that are associated with the document chunks that are included in the one or more second document subsets, the computing system can obtain information indicative of selection of the one or more second document subsets from the plurality of document subsets by the user. In some implementations, the user interface comprises a document subset selection tool that enables the user to provide a user input to select the one or more selected document subsets from the plurality of document subsets. In some implementations, the document subset selection tool provides a graphical representation of the plurality of document subsets. In some implementations, the document subset selection tools enables the user to apply a set of filter logic to the plurality of document subsets. Application of the filter logic selects the one or more selected document subsets from the plurality of document subsets.

In some implementations, prior to performing the second similarity search for the second text embedding with respect to only the chunk embeddings that are associated with the document chunks that are included in the one or more second document subsets, the computing system can select the one or more second document subsets from the plurality of document subsets based at least in part on the second set of text generated by the user.

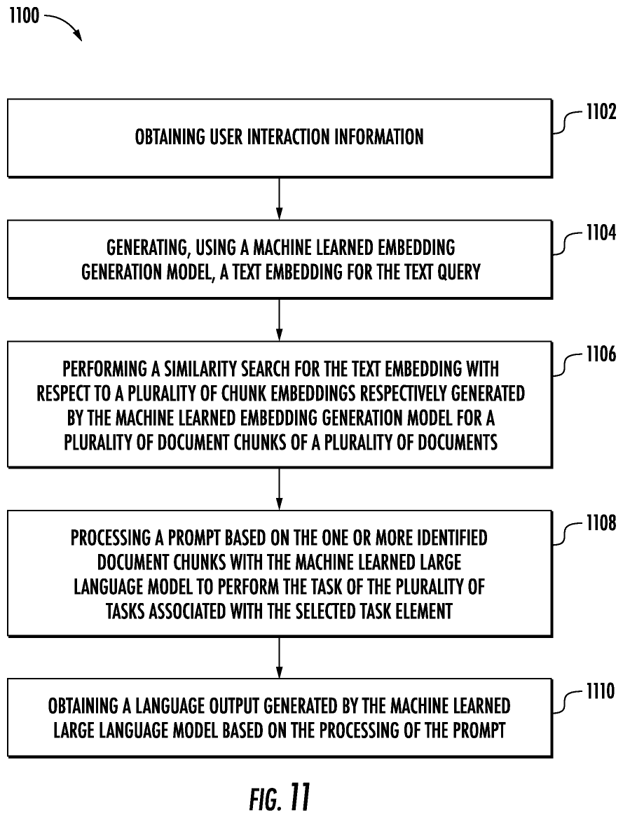

FIG. 11 depicts a flow chart diagram of an example method 1100 to perform facilitation of selection of particular language tasks to enhance user interactions with large language models according to example embodiments of the present disclosure. Although FIG. 11 depicts steps performed in a particular order for purposes of illustration and discussion, the methods of the present disclosure are not limited to the particularly illustrated order or arrangement. The various steps of the method 1100 can be omitted, rearranged, combined, and/or adapted in various ways without deviating from the scope of the present disclosure.

At 1102, a computing system can obtain user interaction information. The user interaction information can indicate (a) a text query comprising at least a portion of a set of text generated by a user through interaction with a text-editing field of a user interface, wherein the user interface comprises the text-editing field and a plurality of selectable task elements respectively associated with a plurality of tasks for a machine-learned large language model, and (b) a selected task element selected from the plurality of selectable text elements by the user.

At 1104, the computing system can generate, using a machine-learned embedding generation model, a text embedding for the text query.

At 1106, the computing system perform a similarity search for the text embedding with respect to a plurality of chunk embeddings respectively generated by the machine-learned embedding generation model for a plurality of document chunks of a plurality of documents. The similarity search identifies as semantically similar to the text query one or more identified document chunks of the plurality of document chunks.

In some implementations, prior to performing the similarity search for the text embedding with respect to the plurality of chunk embeddings respectively generated by the machine-learned embedding generation model for the plurality of document chunks of the plurality of documents, the computing system can access the plurality of chunk embeddings respectively generated by the machine-learned embedding generation model for the plurality of document chunks of the plurality of documents, wherein the plurality of documents are organized into a plurality of document subsets. The computing system can obtain data indicative of one or more selected document subsets of the plurality of document subsets. In some implementations, obtaining the data indicative of the one or more selected document subsets can include obtaining data indicative of selection one or more selected document subsets of the plurality of document subsets via interaction with the user interface by the user.

In some implementations, performing the similarity search for the text embedding can include performing a similarity search for the text embedding with respect to only chunk embeddings that are associated with document chunks that are included in the one or more selected document subsets, wherein the similarity search identifies as semantically similar to the text query one or more identified document chunks of the plurality of document chunks that are included in the one or more selected document subsets.

At 1108, the computing system can process a prompt based on the one or more identified document chunks with the machine-learned large language model to perform the task of the plurality of tasks associated with the selected task element.

At 1110, the computing system can obtain a language output generated by the machine-learned large language model based on the processing of the prompt.

In some implementations, the computing system can provide the language output for display within a user interface associated with a word processing application. In some implementations, providing the language output for display within the user interface further can include providing attribution information for display within the user interface, wherein the attribution information identifies a document of the one or more document subsets that includes an identified document chunk of the one or more identified document chunks.

In some implementations, the text query can include a second text query received subsequent to a previous text query, and wherein the second text query is responsive to a prior language output based on the previous text query.

In some implementations, the selected task element is associated with an idea expansion task of the plurality of tasks, and wherein the one or more identified document chunks comprises a plurality of identified document chunks. Processing the prompt based on the one or more identified document chunks with the machine-learned large language model to perform the task can include, for a plurality of iterations, processing, by the computing system, a new prompt to obtain an updated language output, wherein the new prompt is based on one or more of (a) a subset of identified document chunks of the plurality of identified document chunks or (b) a prior updated language output.

In some implementations, the selected task element is associated with a summarization task of the plurality of tasks. Processing the prompt based on the one or more identified document chunks with the machine-learned large language model to perform the task can include processing the prompt based on the one or more identified document chunks with the machine-learned large language model to obtain the language output, wherein the language output comprises a summarization of the one or more identified document chunks.

In some implementations, the selected task element is associated with a simplification task of the plurality of tasks. Processing the prompt based on the one or more identified document chunks with the machine-learned large language model to perform the task can include processing the prompt based on the one or more identified document chunks with the machine-learned large language model to obtain the language output. The computing system can use the machine-learned large language model to generate a simplified language output descriptive of a simplified representation of the language output.

In some implementations, selected task element is associated with an oppositional view task of the plurality of tasks. Processing the prompt based on the one or more identified document chunks with the machine-learned large language model to perform the task can include processing the prompt based on the one or more identified document chunks with the machine-learned large language model to obtain the language output. The language output is descriptive of a viewpoint. The computing system can use the machine-learned large language model to generate a second language output that is descriptive of a second viewpoint opposite to that of the viewpoint.

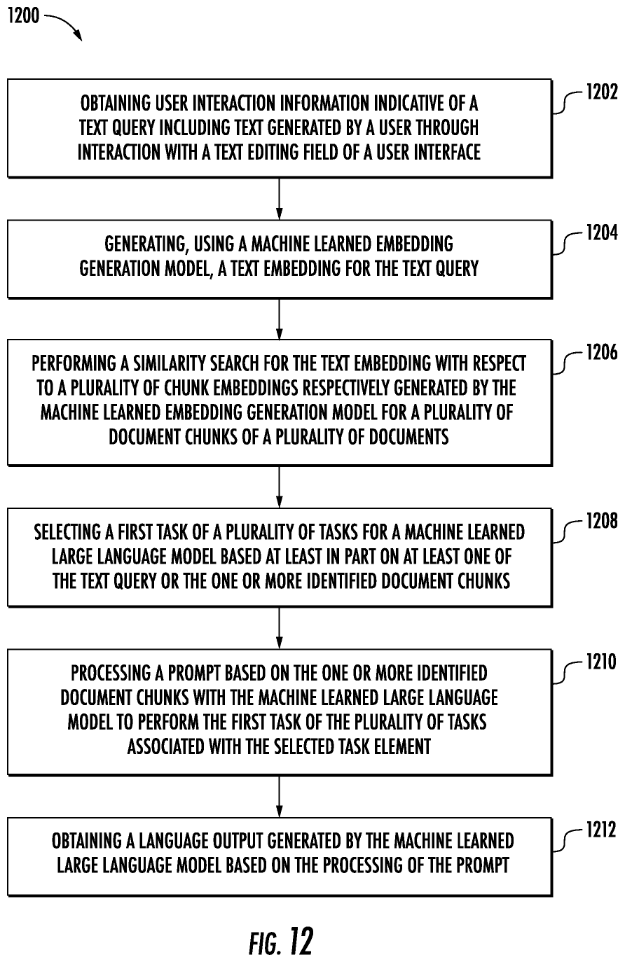

FIG. 12 depicts a flow chart diagram of an example method 1200 to perform dynamic selection of tasks for a large language model according to example embodiments of the present disclosure according to example embodiments of the present disclosure. Although FIG. 12 depicts steps performed in a particular order for purposes of illustration and discussion, the methods of the present disclosure are not limited to the particularly illustrated order or arrangement. The various steps of the method 1200 can be omitted, rearranged, combined, and/or adapted in various ways without deviating from the scope of the present disclosure.

At 1202, a computing system can obtain user interaction information indicative of a text query comprising at least a portion of a set of text generated by a user through interaction with a text-editing field of a user interface.

At 1204, the computing system can generate, using a machine-learned embedding generation model, a text embedding for the text query.

At 1206, the computing system can perform a similarity search for the text embedding with respect to a plurality of chunk embeddings respectively generated by the machine-learned embedding generation model for a plurality of document chunks of a plurality of documents. The similarity search identifies as semantically similar to the text query one or more identified document chunks of the plurality of document chunks.

At 1208, the computing system can select a first task of a plurality of tasks for a machine-learned large language model based at least in part on at least one of the text query or the one or more identified document chunks.

At 1210, the computing system can process a prompt based on the one or more identified document chunks with the machine-learned large language model to perform the first task of the plurality of tasks associated with the selected task element.

At 1212, the computing system can obtain a language output generated by the machine-learned large language model based on the processing of the prompt.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

### Implementations

The following implementations include some of the many implementations described herein. While processes in the figures may show a particular order of operations performed by certain implementations of the present disclosure, it should be understood that such order is exemplary (e.g., alternative implementations may perform the operations in a different order, combine certain operations, overlap certain operations, etc.).

Implementation 1: computer-implemented method for semantic exploration of a specified subset of a plurality of documents, the method comprising:
receiving, by a computing system comprising one or more computing devices, data indicative of a text query;

generating, by the computing system using a machine-learned embedding generation model, a text embedding for the text query;
accessing, by the computing system, a plurality of chunk embeddings respectively generated by the machine-learned embedding generation model for a plurality of document chunks of the plurality of documents, wherein the plurality of documents are organized into a plurality of document subsets;
obtaining, by the computing system, data indicative of one or more selected document subsets of the plurality of document subsets;
performing, by the computing system, a similarity search for the text embedding with respect to only chunk embeddings that are associated with document chunks that are included in the one or more selected document subsets, wherein the similarity search identifies one or more of the chunk embeddings as semantically similar to the text query; and
providing, by the computing system for display within a user interface, one or more of the plurality of document chunks that correspond to the one or more of the chunk embeddings identified by the similarity search.

Implementation 2: The computer-implemented method of implementation 1, wherein the user interface comprises a text-editing interface associated with a word processing application.

Implementation 3: computer-implemented method of implementation 2, wherein:
the user interface comprises a primary text-editing field that enables a user of the user interface to generate a set of text; and
the text query comprises at least a portion of the set of text generated by the user through interaction with the primary text-editing field.

Implementation 4: The computer-implemented method of implementation 2, wherein the user interface comprises:
a primary text-editing field that enables the user to generate a set of text; and
a query field, separate from the primary text-editing field, that enables the user to enter the text query separate from the set of text.

Implementation 5: The computer-implemented method of any preceding implementation, wherein the one or more selected document subsets are specified by the user.

Implementation 6: The computer-implemented method of implementation 5, wherein the user interface comprises a document subset selection tool that enables the user to provide a user input to select the one or more selected document subsets from the plurality of document subsets

Implementation 7: The computer-implemented method of implementation 6, wherein the document subset selection tool provides a graphical representation of the plurality of document subsets

Implementation 8: The computer-implemented method of implementation 6 or 7, wherein the document subset selection tools enables the user to apply a set of filter logic to the plurality of document subsets, wherein application of the filter logic selects the one or more selected document subsets from the plurality of document subsets.

Implementation 9: The computer-implemented method of any preceding implementation, wherein at least some of the documents included in the one or more selected document subsets comprise documents supplied by the user.

Implementation 10: The computer-implemented method of any preceding implementation, wherein at least some of the documents included in the one or more selected document subsets comprise:
books;
product manuals;
legal opinions;
academic papers;
proprietary data files; or
patents documents.

Implementation 11: The computer-implemented method of any preceding implementation, further comprising:
obtaining, by the computing system, the plurality of documents;
parsing, by the computing system, the plurality of documents into the plurality of document chunks; and
generating, by the computing system using the machine-learned embedding generation model, the plurality of chunk embeddings.
Implementation 12: A computer system for semantic exploration of a specified subset of a plurality of documents, the computer system comprising:
one or more processors; and
one or more non-transitory computer-readable media that collectively store:
   a plurality of chunk embeddings respectively generated by a machine-learned embedding generation model for a plurality of document chunks of the plurality of documents, wherein the plurality of documents are organized into a plurality of document subsets; and
   instructions that, when executed by the one or more processors, cause the computer system to perform operations, the operations comprising:
      receiving data indicative of a text query;
      generating, using the machine-learned embedding generation model, a text embedding for the text query;
      obtaining data indicative of one or more selected document subsets of the plurality of document subsets;
      performing a similarity search for the text embedding with respect to only chunk embeddings that are associated with document chunks that are included in the one or more selected document subsets, wherein the similarity search identifies one or more of the chunk embeddings as semantically similar to the text query; and
      providing, for display within a user interface, one or more of the plurality of document chunks that correspond to the one or more of the chunk embeddings identified by the similarity search.

Implementation 13: The computer system of implementation 12, wherein the user interface comprises a text-editing interface associated with a word processing application.

Implementation 14: The computer system of implementation 13, wherein:
the user interface comprises a primary text-editing field that enables the user to generate a set of text; and
the text query comprises at least a portion of the set of text generated by the user through interaction with the primary text-editing field.

Implementation 15: The computer system of implementation 13, wherein the user interface comprises:
a primary text-editing field that enables the user to generate a set of text; and
a query field, separate from the primary text-editing field, that enables the user to enter the text query separate from the set of text.

Implementation 16: The computer system of any of implementations 12-15, wherein the one or more selected document subsets are specified by the user.

Implementation 17: The computer system of implementation 16, wherein the user interface comprises a document subset selection tool that enables the user to provide a user input to select the one or more selected document subsets from the plurality of document subsets.

Implementation 18: The computer system of implementation 17, wherein the document subset selection tool provides a graphical representation of the plurality of document subsets.

Implementation 19: The computer system of implementation 17 or 18, wherein the document subset selection tools enables the user to apply a set of filter logic to the plurality of document subsets, wherein application of the filter logic selects the one or more selected document subsets from the plurality of document subsets.

Implementation 20: The computer system of any of implementations 12-19, wherein the operations further comprise:
obtaining the plurality of documents;
parsing the plurality of documents into the plurality of document chunks; and
generating, using the machine-learned embedding generation model, the plurality of chunk embeddings.

Implementation 21: A computer-implemented method for large language model interactions with improved explainability, the method comprising:
receiving, by a computing system comprising one or more computing devices, data indicative of a text query;
generating, by the computing system using a machine-learned embedding generation model, a text embedding for the text query;
performing, by the computing system, a similarity search for the text embedding with respect to a plurality of chunk embeddings respectively generated by the machine-learned embedding generation model for a plurality of document chunks of a plurality of documents, wherein the similarity search identifies as semantically similar to the text query one or more identified document chunks of the plurality of document chunks;
generating, by the computing system, a prompt that comprises the one or more identified document chunks;
providing, by the computing system, the prompt as an input to and for processing by a machine-learned large language model;
receiving, by the computing system, a language output generated by the machine-learned large language model based on the processing of the prompt; and
providing, by the computing system, the language output as an output.

Implementation 22: The computer-implemented method of implementation 21, wherein, prior to performing the similarity search for the text embedding with respect to the plurality of chunk embeddings respectively generated by the machine-learned embedding generation model for the plurality of document chunks of the plurality of documents, the method comprises accessing, by the computing system, the plurality of chunk embeddings respectively generated by the machine-learned embedding generation model for the plurality of document chunks of the plurality of documents, wherein the plurality of documents are organized into a plurality of document subsets.

Implementation 23: The computer-implemented method of implementation 22, wherein accessing the plurality of chunk embeddings respectively generated by the machine-learned embedding generation model for the plurality of document chunks of the plurality of documents further comprises obtaining, by the computing system, data indicative of one or more selected document subsets of the plurality of document subsets.

Implementation 24: The computer-implemented method of implementation 23, wherein performing the similarity search for the text embedding comprises performing, by the computing system, a similarity search for the text embedding with respect to only chunk embeddings that are associated with document chunks that are included in the one or more selected document subsets, wherein the similarity search identifies as semantically similar to the text query one or more identified document chunks of the plurality of document chunks that are included in the one or more selected document subsets.

Implementation 25: The computer-implemented method of implementation 24, wherein providing the language output as an output comprises providing, by the computing system, the language output for display within a user interface associated with a word processing application.

Implementation 26: The computer-implemented method of implementation 25, wherein providing the language output for display within the user interface further comprises providing, by the computing system, attribution information for display within the user interface, wherein the attribution information identifies a document of the one or more selected document subsets that includes an identified document chunk of the one or more identified document chunks.

Implementation 27: The computer-implemented method of implementation 26, wherein the attribution information is descriptive of a location of the identified document chunk within the document.

Implementation 28: The computer-implemented method of implementation 25, wherein the user interface comprises a primary text-editing field that enables a user of the user interface to generate a set of text; and the text query comprises at least a portion of the set of text generated by the user through interaction with the primary text-editing field.

Implementation 29: The computer-implemented method of implementation 28, wherein the one or more selected document subsets are specified by the user.

Implementation 30: The computer-implemented method of any of implementations 28-29, wherein the method further comprises receiving, by the computing system, data indicative of a second text query comprising at least a portion of a second set of text generated by the user through interaction with the primary text-editing field, wherein the second set of text is responsive to the language output.

Implementation 31: The computer-implemented method of implementation 30, wherein the method further comprises:
generating, by the computing system using the machine-learned embedding generation model, a second text embedding for the second text query;
performing, by the computing system, a second similarity search for the second text embedding with respect to only chunk embeddings that are associated with document chunks that are included in one or more second document subsets of the plurality of document subsets, wherein the second similarity search identifies as semantically similar to the second text query one or more second identified document chunks of the document chunks that are included in the one or more second document subsets;
generating, by the computing system, a second prompt that comprises the one or more second identified document chunks;
providing, by the computing system, the second prompt as an input to and for processing by the machine-learned large language model;
receiving, by the computing system, a second language output generated by the machine-learned large language model based on the processing of the second prompt; and
providing, by the computing system, the second language output for display within the user interface associated with the word processing application.

Implementation 32: The computer-implemented method of implementation 31, wherein, prior to performing the second similarity search for the second text embedding with respect to only the chunk embeddings that are associated with the document chunks that are included in the one or more second document subsets, the method comprises obtaining, by the computing system, information indicative of selection of the one or more second document subsets from the plurality of document subsets by the user.

Implementation 33: The computer-implemented method of implementation 32, wherein the user interface comprises a document subset selection tool that enables the user to provide a user input to select the one or more selected document subsets from the plurality of document subsets.

Implementation 34: The computer-implemented method of implementation 33, wherein the document subset selection tool provides a graphical representation of the plurality of document subsets.

Implementation 35: The computer-implemented method of implementations 33 or 34, wherein the document subset selection tools enables the user to apply a set of filter logic to the plurality of document subsets, wherein application of the filter logic selects the one or more selected document subsets from the plurality of document subsets.

Implementation 36: The computer-implemented method of implementation 31, wherein, prior to performing the second similarity search for the second text embedding with respect to only the chunk embeddings that are associated with the document chunks that are included in the one or more second document subsets, the method comprises selecting, by the computing system, the one or more second document subsets from the plurality of document subsets based at least in part on the second set of text generated by the user.

Implementation 37: A computer system for large language model interactions with improved explainability, the computer system comprising:
one or more processors; and
one or more non-transitory computer-readable media that collectively store instructions that, when executed by the one or more processors, cause the computer system to perform operations, the operations comprising:
   receiving data indicative of a text query;
   generating, using a machine-learned embedding generation model, a text embedding for the text query;
   performing a similarity search for the text embedding with respect to a plurality of chunk embeddings respectively generated by the machine-learned embedding generation model for a plurality of document chunks of a plurality of documents, wherein the similarity search identifies as semantically similar to the text query one or more identified document chunks of the plurality of document chunks;
   generating a prompt that comprises the one or more identified document chunks;
   providing the prompt as an input to and for processing by a machine-learned large language model;
   receiving a language output generated by the machine-learned large language model based on the processing of the prompt; and
   providing the language output as an output.

Implementation 38: The computer system of implementation 37, wherein, prior to performing the similarity search for the text embedding with respect to the plurality of chunk embeddings respectively generated by the machine-learned embedding generation model for the plurality of document chunks of the plurality of documents, the operations comprise accessing the plurality of chunk embeddings respectively generated by the machine-learned embedding generation model for the plurality of document chunks of the plurality of documents, wherein the plurality of documents are organized into a plurality of document subsets.

Implementation 39: The computer system of implementation 38, wherein accessing the plurality of chunk embeddings respectively generated by the machine-learned embedding generation model for the plurality of document chunks of the plurality of documents further comprises obtaining data indicative of one or more selected document subsets of the plurality of document subsets.

Implementation 40: One or more non-transitory computer-readable media that store instructions that, when executed by one or more processors of a computing system, cause the computing system to perform operations, the operations comprising:
receiving data indicative of a text query;
generating, using a machine-learned embedding generation model, a text embedding for the text query;
performing a similarity search for the text embedding with respect to a plurality of chunk embeddings respectively generated by the machine-learned embedding generation model for a plurality of document chunks of a plurality of documents, wherein the similarity search identifies as semantically similar to the text query one or more identified document chunks of the plurality of document chunks;
generating a prompt that comprises the one or more identified document chunks;
providing the prompt as an input to and for processing by a machine-learned large language model;
receiving a language output generated by the machine-learned large language model based on the processing of the prompt; and
providing the language output as an output.

Implementation 41: A computer-implemented method for facilitating selection of particular language tasks to enhance user interactions with large language models, the method comprising:
obtaining, by a computing system comprising one or more computing devices, user interaction information indicative of:
   a text query comprising at least a portion of a set of text generated by a user through interaction with a text-editing field of a user interface, wherein the user interface comprises the text-editing field and a plurality of selectable task elements respectively associated with a plurality of tasks for a machine-learned large language model; and
   a selected task element selected from the plurality of selectable task elements by the user;
generating, by the computing system using a machine-learned embedding generation model, a text embedding for the text query;
performing, by the computing system, a similarity search for the text embedding with respect to a plurality of chunk embeddings respectively generated by the machine-learned embedding generation model for a plurality of document chunks of a plurality of documents, wherein the similarity search identifies as semantically similar to the text query one or more identified document chunks of the plurality of document chunks;
processing, by the computing system, a prompt based on the one or more identified document chunks with the machine-learned large language model to perform the task of the plurality of tasks associated with the selected task element; and
obtaining, by the computing system, a language output generated by the machine-learned large language model based on the processing of the prompt.

Implementation 42: The computer-implemented method of implementation 41, wherein, prior to performing the similarity search for the text embedding with respect to the plurality of chunk embeddings respectively generated by the machine-learned embedding generation model for the plurality of document chunks of the plurality of documents, the method comprises accessing, by the computing system, the plurality of chunk embeddings respectively generated by the machine-learned embedding generation model for the plurality of document chunks of the plurality of documents, wherein the plurality of documents are organized into a plurality of document subsets; and obtaining, by the computing system, data indicative of one or more selected document subsets of the plurality of document subsets.

Implementation 43: The computer-implemented method of implementation 42, wherein obtaining the data indicative of the one or more selected document subsets comprises obtaining, by the computing system, data indicative of selection one or more selected document subsets of the plurality of document subsets via interaction with the user interface by the user.

Implementation 44: The computer-implemented method of any of implementations 42-43, wherein performing the similarity search for the text embedding comprises performing, by the computing system, a similarity search for the text embedding with respect to only chunk embeddings that are associated with document chunks that are included in the one or more selected document subsets, wherein the similarity search identifies as semantically similar to the text query one or more identified document chunks of the plurality of document chunks that are included in the one or more selected document subsets.

Implementation 45: The computer-implemented method of implementation 44, wherein the method further comprises providing, by the computing system, the language output for display within a user interface associated with a word processing application.

Implementation 46: The computer-implemented method of implementation 45, wherein providing the language output for display within the user interface further comprises providing, by the computing system, attribution information for display within the user interface, wherein the attribution information identifies a document of the one or more selected document subsets that includes an identified document chunk of the one or more identified document chunks.

Implementation 47: The computer-implemented method of any of implementations 41-46, wherein the text query comprises a second text query received subsequent to a previous text query, and wherein the second text query is responsive to a prior language output based on the previous text query.

Implementation 48: The computer-implemented method of any of implementations 41-47, wherein the selected task element is associated with an idea expansion task of the plurality of tasks, and wherein the one or more identified document chunks comprises a plurality of identified document chunks; and wherein processing the prompt based on the one or more identified document chunks with the machine-learned large language model to perform the task comprises: for a plurality of iterations, processing, by the computing system, a new prompt to obtain an updated language output, wherein the new prompt is based on one or more of (a) a subset of identified document chunks of the plurality of identified document chunks or (b) a prior updated language output.

Implementation 49: The computer-implemented method of any of implementations 41-47, wherein the selected task element is associated with a summarization task of the plurality of tasks; and wherein processing the prompt based on the one or more identified document chunks with the machine-learned large language model to perform the task comprises processing, by the computing system, the prompt based on the one or more identified document chunks with the machine-learned large language model to obtain the language output, wherein the language output comprises a summarization of the one or more identified document chunks.

Implementation 50: The computer-implemented method of any of implementations 41-47, wherein the selected task element is associated with a simplification task of the plurality of tasks; and wherein processing the prompt based on the one or more identified document chunks with the machine-learned large language model to perform the task comprises:
processing, by the computing system, the prompt based on the one or more identified document chunks with the machine-learned large language model to obtain the language output; and
using, by the computing system, the machine-learned large language model to generate a simplified language output descriptive of a simplified representation of the language output.

Implementation 51: The computer-implemented method of any of implementations 41-47, wherein the selected task element is associated with an oppositional view task of the plurality of tasks; and wherein processing the prompt based on the one or more identified document chunks with the machine-learned large language model to perform the task comprises:
processing, by the computing system, the prompt based on the one or more identified document chunks with the machine-learned large language model to obtain the language output, wherein the language output is descriptive of a viewpoint; and
using, by the computing system, the machine-learned large language model to generate a second language output that is descriptive of a second viewpoint opposite to that of the viewpoint.

Implementation 52: A computer system for facilitating selection of particular language tasks to enhance user interactions with large language models, the computer system comprising:
one or more processors; and
one or more non-transitory computer-readable media that collectively store instructions that, when executed by the one or more processors, cause the computer system to perform operations, the operations comprising:
   obtaining user interaction information indicative of:
      a text query comprising at least a portion of a set of text generated by a user through interaction with a text-editing field of a user interface, wherein the user interface comprises the text-editing field and a plurality of selectable task elements respectively associated with a plurality of tasks for a machine-learned large language model; and
      a selected task element selected from the plurality of selectable task elements by the user;
   generating, using a machine-learned embedding generation model, a text embedding for the text query;
   performing a similarity search for the text embedding with respect to a plurality of chunk embeddings respectively generated by the machine-learned embedding generation model for a plurality of document chunks of a plurality of documents, wherein the similarity search identifies as semantically similar to the text query one or more identified document chunks of the plurality of document chunks;
   processing a prompt based on the one or more identified document chunks with the machine-learned large language model to perform the task of the plurality of tasks associated with the selected task element; and
   obtaining a language output generated by the machine-learned large language model based on the processing of the prompt.

Implementation 53: The computer system of implementation 52, wherein, prior to performing the similarity search for the text embedding with respect to the plurality of chunk embeddings respectively generated by the machine-learned embedding generation model for the plurality of document chunks of the plurality of documents, the operations comprise:
accessing the plurality of chunk embeddings respectively generated by the machine-learned embedding generation model for the plurality of document chunks of the plurality of documents, wherein the plurality of documents are organized into a plurality of document subsets; and
obtaining data indicative of one or more selected document subsets of the plurality of document subsets.

Implementation 54: The computer system of implementation 53, wherein obtaining the data indicative of the one or more selected document subsets comprises obtaining data indicative of selection one or more selected document subsets of the plurality of document subsets via interaction with the user interface by the user.

Implementation 55: The computer system of implementation 53, wherein performing the similarity search for the text embedding comprises performing a similarity search for the text embedding with respect to only chunk embeddings that are associated with document chunks that are included in the one or more selected document subsets, wherein the similarity search identifies as semantically similar to the text query one or more identified document chunks of the plurality of document chunks that are included in the one or more selected document subsets.

Implementation 56: The computer system of implementation 55, wherein the operations further comprise providing the language output for display within a user interface associated with a word processing application; and wherein providing the language output for display within the user interface further comprises providing attribution information for display within the user interface, wherein the attribution information identifies a document of the one or more selected document subsets that includes an identified document chunk of the one or more identified document chunks.

Implementation 57: The computer system of any of implementations 52-56, wherein the text query comprises a second text query received subsequent to a previous text query, and wherein the second text query is responsive to a prior language output based on the previous text query.

Implementation 58: The computer system of any of implementations 52-56, wherein the selected task element is associated with an idea expansion task of the plurality of tasks, and wherein the one or more identified document chunks comprises a plurality of identified document chunks; and wherein processing the prompt based on the one or more identified document chunks with the machine-learned large language model to perform the task comprises, for a plurality of iterations, processing a prompt based on a different subset of identified document chunks of the plurality of identified document chunks to obtain a respective plurality of outputs, wherein the language output comprises at least some of the plurality of outputs.

Implementation 59: The computer system of any of implementations 52-56, wherein the selected task element is associated with a summarization task of the plurality of tasks; and wherein processing the prompt based on the one or more identified document chunks with the machine-learned large language model to perform the task comprises:
processing the prompt based on the one or more identified document chunks with the machine-learned large language model to obtain the language output; and
using the machine-learned large language model to generate a summarization of the language output.

Implementation 60: One or more non-transitory computer-readable media that store instructions that, when executed by one or more processors of a computing system, cause the computing system to perform operations, the operations comprising:
obtaining user interaction information indicative of:
   a text query comprising at least a portion of a set of text generated by a user through interaction with a text-editing field of a user interface, wherein the user interface comprises the text-editing field and a plurality of selectable task elements respectively associated with a plurality of tasks for a machine-learned large language model; and
   a selected task element selected from the plurality of selectable task elements by the user;
generating, using a machine-learned embedding generation model, a text embedding for the text query;
performing a similarity search for the text embedding with respect to a plurality of chunk embeddings respectively generated by the machine-learned embedding generation model for a plurality of document chunks of a plurality of documents, wherein the similarity search identifies as semantically similar to the text query one or more identified document chunks of the plurality of document chunks;
processing a prompt based on the one or more identified document chunks with the machine-learned large language model to perform the task of the plurality of tasks associated with the selected task element; and
obtaining a language output generated by the machine-learned large language model based on the processing of the prompt.

Implementation 61: A computer-implemented method for dynamic selection of tasks for a large language model, the method comprising:
obtaining, by a computing system comprising one or more computing devices, user interaction information indicative of a text query comprising at least a portion of a set of text generated by a user through interaction with a text-editing field of a user interface;
generating, by the computing system using a machine-learned embedding generation model, a text embedding for the text query;
performing, by the computing system, a similarity search for the text embedding with respect to a plurality of chunk embeddings respectively generated by the machine-learned embedding generation model for a plurality of document chunks of a plurality of documents, wherein the similarity search identifies as semantically similar to the text query one or more identified document chunks of the plurality of document chunks;
selecting, by the computing system, a first task of a plurality of tasks for a machine-learned large language model based at least in part on at least one of the text query or the one or more identified document chunks; and
processing, by the computing system, a prompt based on the one or more identified document chunks with the machine-learned large language model to perform the first task of the plurality of tasks; and
obtaining, by the computing system, a language output generated by the machine-learned large language model based on the processing of the prompt.

Implementation 62: The computer-implemented method of implementation 61, wherein, prior to performing the similarity search for the text embedding with respect to the plurality of chunk embeddings respectively generated by the machine-learned embedding generation model for the plurality of document chunks of the plurality of documents, the method comprises:
accessing, by the computing system, the plurality of chunk embeddings respectively generated by the machine-learned embedding generation model for the plurality of document chunks of the plurality of documents, wherein the plurality of documents are organized into a plurality of document subsets; and
obtaining, by the computing system, data indicative of one or more selected document subsets of the plurality of document subsets.

Implementation 63: The computer-implemented method of implementation 62, wherein obtaining the data indicative of the one or more selected document subsets comprises obtaining, by the computing system, data indicative of selection one or more selected document subsets of the plurality of document subsets via interaction with the user interface by the user.

Implementation 64: The computer-implemented method of any of implementations 62-63, wherein performing the similarity search for the text embedding comprises performing, by the computing system, a similarity search for the text embedding with respect to only chunk embeddings that are associated with document chunks that are included in the one or more selected document subsets, wherein the similarity search identifies as semantically similar to the text query one or more identified document chunks of the plurality of document chunks that are included in the one or more selected document subsets.

Implementation 65: The computer-implemented method of implementation 64, wherein the method further comprises providing, by the computing system, the language output for display within a user interface associated with a word processing application.

Implementation 66: The computer-implemented method of implementation 65, wherein providing the language output for display within the user interface further comprises providing, by the computing system, attribution information for display within the user interface, wherein the attribution information identifies a document of the one or more selected document subsets that includes an identified document chunk of the one or more identified document chunks.

Implementation 67: The computer-implemented method of any of implementations 61-66, wherein the text query comprises a second text query received subsequent to a previous text query, and wherein the second text query is responsive to a prior language output based on the previous text query.

Implementation 68: The computer-implemented method of any of implementations 61-67, wherein selecting the first task of the plurality of tasks for the machine-learned large language model based at least in part on the at least one of the text query or the one or more identified document chunks comprises:
determining, by the computing system, a complexity metric descriptive of a degree of complexity associated with the text query and/or the one or more identified document chunks;
making, by the computing system, a determination that the complexity metric is greater than a threshold degree of complexity; and
selecting, by the computing system, a simplification task of the plurality of tasks for the machine-learned large language model based on the determination.

Implementation 69: The computer-implemented method of implementation 68, wherein processing the prompt based on the one or more identified document chunks with the machine-learned large language model to perform the task comprises:
processing, by the computing system, the prompt based on the one or more identified document chunks with the machine-learned large language model to obtain the language output; and
using, by the computing system, the machine-learned large language model to generate a simplified language output descriptive of a simplified representation of the language output.

Implementation 70: The computer-implemented method of implementation 69, wherein the method further comprises: displaying, by the computing system, the simplified language output within the user interface adjacent to the language output.

Implementation 71: The computer-implemented method of implementation 69, wherein the method further comprises: displaying, by the computing system, the simplified language output within a second user interface different than the user interface.

Implementation 72: The computer-implemented method of implementation 69, wherein the method further comprises: displaying, by the computing system, the simplified language output to replace the language output within the user interface.

Implementation 73: The computer-implemented method of any of implementations 61-67, wherein selecting the first task of the plurality of tasks for the machine-learned large language model based at least in part on the at least one of the text query or the one or more identified document chunks comprises:
making, by the computing system, a determination that the text query and/or the one or more identified document chunks comprises textual content that expresses an opinion; and
selecting, by the computing system, an oppositional view task of the plurality of tasks for the machine-learned large language model based on the determination.

Implementation 74: The computer-implemented method of implementation 73, wherein processing the prompt based on the one or more identified document chunks with the machine-learned large language model to perform the task comprises:
processing, by the computing system, the prompt based on the one or more identified document chunks with the machine-learned large language model to obtain the language output, wherein the language output is descriptive of a viewpoint; and
using, by the computing system, the machine-learned large language model to generate a second language output that is descriptive of a second viewpoint opposite to that of the viewpoint.

Implementation 75: The computer-implemented method of any of implementations 61-67, wherein the first task is an idea expansion task, wherein the one or more identified document chunks comprises a plurality of identified document chunks; and wherein processing the prompt based on the one or more identified document chunks with the machine-learned large language model to perform the task comprises: for a plurality of iterations, processing, by the computing system, a new prompt to obtain an updated language output, wherein the new prompt is based on one or more of (a) a subset of identified document chunks of the plurality of identified document chunks or (b) a prior updated language output.

Implementation 76: A computer system for dynamic selection of tasks for a large language model, the computer system comprising:
one or more processors; and
one or more non-transitory computer-readable media that collectively store instructions that, when executed by the one or more processors, cause the computer system to perform operations, the operations comprising:
obtaining user interaction information indicative of a text query comprising at least a portion of a set of text generated by a user through interaction with a text-editing field of a user interface; and
generating, using a machine-learned embedding generation model, a text embedding for the text query;
performing a similarity search for the text embedding with respect to a plurality of chunk embeddings respectively generated by the machine-learned embedding generation model for a plurality of document chunks of a plurality of documents, wherein the similarity search identifies as semantically similar to the text query one or more identified document chunks of the plurality of document chunks;
selecting a first task of a plurality of tasks for a machine-learned large language model based at least in part on at least one of the text query or the one or more identified document chunks; and
processing a prompt based on the one or more identified document chunks with the machine-learned large language model to perform the first task of the plurality of tasks; and
obtaining a language output generated by the machine-learned large language model based on the processing of the prompt.

Implementation 77: The computer system of implementation 76, wherein, prior to performing the similarity search for the text embedding with respect to the plurality of chunk embeddings respectively generated by the machine-learned embedding generation model for the plurality of document chunks of the plurality of documents, the operations comprise:
accessing the plurality of chunk embeddings respectively generated by the machine-learned embedding generation model for the plurality of document chunks of the plurality of documents, wherein the plurality of documents are organized into a plurality of document subsets; and
obtaining data indicative of one or more selected document subsets of the plurality of document subsets.

Implementation 78: The computer system of implementation 77, wherein obtaining the data indicative of the one or more selected document subsets comprises obtaining data indicative of selection one or more selected document subsets of the plurality of document subsets via interaction with the user interface by the user.

Implementation 79: The computer system of any of implementations 77-78, wherein performing the similarity search for the text embedding comprises performing a similarity search for the text embedding with respect to only chunk embeddings that are associated with document chunks that are included in the one or more selected document subsets, wherein the similarity search identifies as semantically similar to the text query one or more identified document chunks of the plurality of document chunks that are included in the one or more selected document subsets.

Implementation 80: One or more non-transitory computer-readable media that store instructions that, when executed by one or more processors of a computing system, cause the computing system to perform operations, the operations comprising:
obtaining user interaction information indicative of a text query comprising at least a portion of a set of text generated by a user through interaction with a text-editing field of a user interface; and
generating, using a machine-learned embedding generation model, a text embedding for the text query;
performing a similarity search for the text embedding with respect to a plurality of chunk embeddings respectively generated by the machine-learned embedding generation model for a plurality of document chunks of a plurality of documents, wherein the similarity search identifies as semantically similar to the text query one or more identified document chunks of the plurality of document chunks;
selecting a first task of a plurality of tasks for a machine-learned large language model based at least in part on at least one of the text query or the one or more identified document chunks; and
processing a prompt based on the one or more identified document chunks with the machine-learned large language model to perform the first task of the plurality of tasks; and
obtaining a language output generated by the machine-learned large language model based on the processing of the prompt.

1. A computer-implemented method for semantic exploration of a specified subset of a plurality of documents, the method comprising:
receiving, by a computing system comprising one or more computing devices, data indicative of a text query;
generating, by the computing system using a machine-learned embedding generation model, a text embedding for the text query;
accessing, by the computing system, a plurality of chunk embeddings respectively generated by the machine-learned embedding generation model for a plurality of document chunks of the plurality of documents, wherein the plurality of documents are organized into a plurality of document subsets;
obtaining, by the computing system, data indicative of one or more selected document subsets of the plurality of document subsets;
performing, by the computing system, a similarity search for the text embedding with respect to only chunk embeddings that are associated with document chunks that are included in the one or more selected document subsets, wherein the similarity search identifies one or more of the chunk embeddings as semantically similar to the text query; and
providing, by the computing system for display within a user interface, one or more of the plurality of document chunks that correspond to the one or more of the chunk embeddings identified by the similarity search.

2. The computer-implemented method of claim 1, wherein the user interface comprises a text-editing interface associated with a word processing application.

3. The computer-implemented method of claim 2, wherein:
the user interface comprises a primary text-editing field that enables a user of the user interface to generate a set of text; and
the text query comprises at least a portion of the set of text generated by the user through interaction with the primary text-editing field.

4. The computer-implemented method of claim 2, wherein the user interface comprises:
a primary text-editing field that enables a user of the user interface to generate a set of text; and
a query field, separate from the primary text-editing field, that enables the user to enter the text query separate from the set of text.

5. The computer-implemented method of claim 1, wherein the one or more selected document subsets are specified by the user.

6. The computer-implemented method of claim 5, wherein the user interface comprises a document subset selection tool that enables the user to provide a user input to select the one or more selected document subsets from the plurality of document subsets.

7. The computer-implemented method of claim 6, wherein the document subset selection tool provides a graphical representation of the plurality of document subsets.

8. The computer-implemented method of claim 6, wherein the document subset selection tools enables the user to apply a set of filter logic to the plurality of document subsets, wherein application of the filter logic selects the one or more selected document subsets from the plurality of document subsets.

9. The computer-implemented method of claim 1, wherein at least some of the documents included in the one or more selected document subsets comprise documents supplied by the user.

10. The computer-implemented method of claim 1, wherein at least some of the documents included in the one or more selected document subsets comprise:
books;
product manuals;
legal opinions;
academic papers;
proprietary data files; or
patents documents.

11. The computer-implemented method of claim 1, further comprising:
obtaining, by the computing system, the plurality of documents;
parsing, by the computing system, the plurality of documents into the plurality of document chunks; and
generating, by the computing system using the machine-learned embedding generation model, the plurality of chunk embeddings.

12. A computer system for semantic exploration of a specified subset of a plurality of documents, the computer system comprising:
one or more processors; and
one or more non-transitory computer-readable media that collectively store:
a plurality of chunk embeddings respectively generated by a machine-learned embedding generation model for a plurality of document chunks of the plurality of documents, wherein the plurality of documents are organized into a plurality of document subsets; and
instructions that, when executed by the one or more processors, cause the computer system to perform operations, the operations comprising:
receiving data indicative of a text query;
generating, using the machine-learned embedding generation model, a text embedding for the text query;
obtaining data indicative of one or more selected document subsets of the plurality of document subsets;
performing a similarity search for the text embedding with respect to only chunk embeddings that are associated with document chunks that are included in the one or more selected document subsets, wherein the similarity search identifies one or more of the chunk embeddings as semantically similar to the text query; and
providing, for display within a user interface, one or more of the plurality of document chunks that correspond to the one or more of the chunk embeddings identified by the similarity search.

13-20. (canceled)

21. A computer-implemented method for large language model interactions with improved explainability, the method comprising:
receiving, by a computing system comprising one or more computing devices, data indicative of a text query;
generating, by the computing system using a machine-learned embedding generation model, a text embedding for the text query;
performing, by the computing system, a similarity search for the text embedding with respect to a plurality of chunk embeddings respectively generated by the machine-learned embedding generation model for a plurality of document chunks of a plurality of documents, wherein the similarity search identifies as semantically similar to the text query one or more identified document chunks of the plurality of document chunks;
generating, by the computing system, a prompt that comprises the one or more identified document chunks;
providing, by the computing system, the prompt as an input to and for processing by a machine-learned large language model;
receiving, by the computing system, a language output generated by the machine-learned large language model based on the processing of the prompt; and
providing, by the computing system, the language output as an output.

22. The computer-implemented method of claim 21, wherein, prior to performing the similarity search for the text embedding with respect to the plurality of chunk embeddings respectively generated by the machine-learned embedding generation model for the plurality of document chunks of the plurality of documents, the method comprises:
accessing, by the computing system, the plurality of chunk embeddings respectively generated by the machine-learned embedding generation model for the plurality of document chunks of the plurality of documents, wherein the plurality of documents are organized into a plurality of document subsets.

23. The computer-implemented method of claim 22, wherein accessing the plurality of chunk embeddings respectively generated by the machine-learned embedding generation model for the plurality of document chunks of the plurality of documents further comprises:
obtaining, by the computing system, data indicative of one or more selected document subsets of the plurality of document subsets.

24. The computer-implemented method of claim 23, wherein performing the similarity search for the text embedding comprises:
performing, by the computing system, a similarity search for the text embedding with respect to only chunk embeddings that are associated with document chunks that are included in the one or more selected document subsets, wherein the similarity search identifies as semantically similar to the text query one or more identified document chunks of the plurality of document chunks that are included in the one or more selected document subsets.

25. The computer-implemented method of claim 24, wherein providing the language output as an output comprises providing, by the computing system, the language output for display within a user interface associated with a word processing application.

26. The computer-implemented method of claim 25, wherein providing the language output for display within the user interface further comprises providing, by the computing system, attribution information for display within the user interface, wherein the attribution information identifies a document of the one or more selected document subsets that includes an identified document chunk of the one or more identified document chunks.

27. The computer-implemented method of claim 26, wherein the attribution information is descriptive of a location of the identified document chunk within the document.

28. The computer-implemented method of claim 25, wherein the user interface comprises a primary text-editing field that enables a user of the user interface to generate a set of text; and
the text query comprises at least a portion of the set of text generated by the user through interaction with the primary text-editing field.

29. The computer-implemented method of claim 28, wherein the one or more selected document subsets are specified by the user.

30. The computer-implemented method of claim 28, wherein the method further comprises:
receiving, by the computing system, data indicative of a second text query comprising at least a portion of a second set of text generated by the user through interaction with the primary text-editing field, wherein the second set of text is responsive to the language output.

31. The computer-implemented method of claim 30, wherein the method further comprises:
generating, by the computing system using the machine-learned embedding generation model, a second text embedding for the second text query;
performing, by the computing system, a second similarity search for the second text embedding with respect to only chunk embeddings that are associated with document chunks that are included in one or more second document subsets of the plurality of document subsets, wherein the second similarity search identifies as semantically similar to the second text query one or more second identified document chunks of the document chunks that are included in the one or more second document subsets;
generating, by the computing system, a second prompt that comprises the one or more second identified document chunks;
providing, by the computing system, the second prompt as an input to and for processing by the machine-learned large language model;
receiving, by the computing system, a second language output generated by the machine-learned large language model based on the processing of the second prompt; and
providing, by the computing system, the second language output for display within the user interface associated with the word processing application.

32. The computer-implemented method of claim 31, wherein, prior to performing the second similarity search for the second text embedding with respect to only the chunk embeddings that are associated with the document chunks that are included in the one or more second document subsets, the method comprises:
obtaining, by the computing system, information indicative of selection of the one or more second document subsets from the plurality of document subsets by the user.

33. The computer-implemented method of claim 32, wherein the user interface comprises a document subset selection tool that enables the user to provide a user input to select the one or more selected document subsets from the plurality of document subsets.

34. The computer-implemented method of claim 33, wherein the document subset selection tool provides a graphical representation of the plurality of document subsets.

35. The computer-implemented method of claim 33, wherein the document subset selection tools enables the user to apply a set of filter logic to the plurality of document subsets, wherein application of the filter logic selects the one or more selected document subsets from the plurality of document subsets.

36. The computer-implemented method of claim 31, wherein, prior to performing the second similarity search for the second text embedding with respect to only the chunk embeddings that are associated with the document chunks that are included in the one or more second document subsets, the method comprises:
selecting, by the computing system, the one or more second document subsets from the plurality of document subsets based at least in part on the second set of text generated by the user.

37-40. (canceled)
